(19) United States
(12) Patent Application Publication
(10) Pub. No.: US 2026/0128387 A1
(43) Pub. Date: May 7, 2026

(54) LEAD-ACID BATTERY AND MANUFACTURE METHOD

(71) Applicant: ARCACTIVE LIMITED, Hornby Christchurch (NZ)

(72) Inventors: Stuart MCKENZIE, Hornby Christchurch (NZ); Shane CHRISTIE, Hornby Christchurch (NZ)

(21) Appl. No.: 19/106,525

(22) PCT Filed: Aug. 25, 2023
(86) PCT No.: PCT/IB2023/058428

§ 371 Date: Feb. 25, 2025

(30) Foreign Application Priority Data
Aug. 30, 2022 (NZ) 791937

(51) Int. Cl. H01M 10/12; H01M 4/02; H01M 4/14; H01M 4/73; H01M 10/18; H01M 50/491

(52) U.S. Cl. CPC H01M 10/12; H01M 4/14; H01M 4/73; H01M 10/18; H01M 50/491; H01M 2004/021; H01M 2004/029

(57) ABSTRACT

Lead-acid batteries or cells, electrodes and bipolar plates for the same, and methods of manufacturing the same are provided. The lead acid batteries comprise a positive and/or negative electrode having a specific pore size diameter distribution. The pore size diameter distribution may comprise: a ratio of a volume of pores having a pore size diameter greater than 20 μm to a total pore volume of at least 15%; or a volume of pores having a pore size diameter greater than 20 μm of at least 0.020 ml/g.

### RELATED APPLICATIONS

This application is a national stage application under 35 U.S.C. 371 for International Application No. PCT/IB2023/058428, filed on Aug. 25, 2023, which claims the benefit of priority of New Zealand Application No. 791937, filed on Aug. 30, 2022, the entire contents of which applications are incorporated herein by reference.

### FIELD OF THE INVENTION

The invention relates to lead-acid batteries or cells, electrodes and bipolar plates for the same, and methods of manufacturing the same.

### BACKGROUND

The decarbonisation of electricity generation is expected to expand the market for batteries. A significant factor in the competitiveness of a battery solution is the cost of the discharged electricity, known as the Levelized Cost of Storage (LCOS). The LCoS of a battery is essentially the net present value (NPV) of all costs associated with installation and operation of the battery (for example, the battery, control equipment, power conversion equipment, housing, cabling etc.) divided by the lifetime energy (kWh) discharged from the battery.

Lead-acid batteries (LABs) have a number of advantages compared to other storage technologies, such as Li-ion batteries, in that they are recyclable, are generally safe and are fundamentally low-cost batteries to produce. However, due to the lower amount of energy throughput over the life of the battery, lead-acid batteries have higher (and thus less attractive) LCOS metrics than Li-ion batteries. A typical absorptive glass mat (AGM) lead-acid battery might achieve 200-500 capacity turnovers before reaching the end of its life, whereas Li-ion can achieve say 2,000 capacity turnovers. A battery is generally considered to have reached the end of its life when it is no longer able to meet the design requirements for the application. For energy storage system (ESS) applications, battery end of life for lead-acid batteries is commonly expressed as having been reached when the discharged capacity is some fraction (for example, 50%) of its initial capacity.

ESS batteries are typically valve regulated lead-acid (VRLA) batteries. In VRLA batteries the electrolyte is immobilized (in contrast to flooded batteries) to reduce electrolyte stratification which degrades and reduces the life of the battery. There are two types of immobilised electrolyte VLRAs: AGM batteries and gel batteries.

AGM batteries include an absorptive glass mat as a separator disposed between the positive and negative electrodes. The glass mat comprises a network of glass fibres of different sizes, typically ranging from about 1 to about 4 mm in length and about 0.5 to about 3 μm in diameter, typically less than about 1 μm in diameter. The mixture of different fibre sizes is to balance competing requirements of electrolyte entrainment, fabric compressibility and incompressibility, and ability to be filled. The fibres entrain the electrolyte due to the high surface tension between the electrolyte and fibres, thus immobilising the electrolyte. Battery manufacturers target separator saturation levels that are high, but not fully saturated, which provide gas channels for O₂ gas produced at the positive electrode to diffuse across the separator and recombine to water at the negative electrode. This reduces water loss from the battery, increasing the turnover capacity of the battery.

Gel batteries include a gelling agent, such as SiO₂ nano powder, which forms a gel that immobilises the electrolyte, helping to prevent, for example stratification, or electrolyte spillage if the battery is tipped on its side, and acts as a separator. Very fine cracks that form in the gel provide gas channels for O₂ diffusion. Gel batteries typically achieve significantly higher turnover capacity than AGM batteries. Whereas an AGM battery might achieve 200-500 100% depth of discharge (DoD) cycles, a gel battery might achieve 1,500 cycles. There are, however, drawbacks to gel batteries. One is that the high internal resistance of the gel separator means that gel batteries are only suitable for certain niche applications.

An important failure mode for VRLA batteries is a phenomenon known as “dry out”. Dry out occurs when the saturation level of the separator drops. This occurs due to an inevitable side reaction that occurs during charging-hydrolysis. While the O₂ that is formed during hydrolysis is typically recombined at the negative electrode, any H₂ that is produced is lost from the battery (due to very low H₂ to water conversion), along with a stoichiometric amount of O₂, meaning that water is slowly lost from the battery.

There is a need for lead-acid batteries with increased capacity turnover and/or reduced water loss. It is an object of the present invention to go some way to meeting this need; and/or to at least provide the public with a useful choice.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### SUMMARY OF INVENTION

In one aspect, the present invention broadly consists in a lead-acid battery or cell, wherein the battery or cell is a non-gel lead-acid battery or cell or an absorptive glass mat (AGM) lead-acid battery or cell, comprising:
a positive electrode comprising a positive active material (PAM);
a negative electrode comprising a negative active material (NAM); and
a separator capable of immobilising an electrolyte disposed between the positive and negative electrodes,
the positive electrode and negative electrode each having a pore size diameter distribution measured by mercury porosimetry,
wherein the pore size diameter distribution of the positive and/or negative electrode comprises a ratio of a volume of pores having a pore size diameter greater than 20 μm to a total pore volume of at least 15%.

In another aspect, the present invention broadly consists in a lead-acid battery or cell, wherein the battery or cell is a non-gel lead-acid battery or cell or an absorptive glass mat (AGM) lead-acid battery or cell, comprising:
a positive electrode comprising a positive active material (PAM);
a negative electrode comprising a negative active material (NAM); and
a separator capable of immobilising an electrolyte disposed between the positive and negative electrodes,
the positive electrode and negative electrode each having a pore size diameter distribution measured by mercury porosimetry,
wherein the pore size diameter distribution of the positive and/or negative electrode comprises a volume of pores having a pore size diameter greater than 20 μm of at least 0.020 ml/g.

In another aspect, the present invention broadly consists in a lead-acid battery or cell, wherein the battery or cell is a non-gel lead-acid battery or cell or an absorptive glass mat (AGM) lead-acid battery or cell, comprising:
a positive electrode comprising a positive active material (PAM);
a negative electrode comprising a negative active material (NAM); and
a separator capable of immobilising an electrolyte disposed between the positive and negative electrodes,
the positive electrode and negative electrode each having a pore size diameter distribution measured by mercury porosimetry,
wherein the pore size diameter distribution of the positive and/or negative electrode comprises:
(a) a ratio of a volume of pores having a pore size diameter greater than 10 μm to a total pore volume of at least 50%, 55%, 60%, 65%, or 70%;
(b) a ratio of a volume of pores having a pore size diameter greater than 15 μm to a total pore volume of at least 25%, 30%, 35%, 40%, 45%, 50%, or 55%;
(c) a ratio of a volume of pores having a pore size diameter greater than 20 μm to a total pore volume of at least 15%, 20%, 25%, 30%, 40%, or 45%;
(d) a ratio of a volume of pores having a pore size diameter greater than 25 μm to a total pore volume of at least 15%, 20%, 25% or 30%;
(e) a ratio of a volume of pores having a pore size diameter greater than 30 μm to a total pore volume of at least 10%, 15%, 20%, or 25%;
(f) a ratio of a volume of pores having a pore size diameter greater than 35 μm to a total pore volume of at least 10%, 15%, or 20%; or
(g) any combination of two or more of (a) to (f).

In another aspect, the present invention broadly consists in a lead-acid battery or cell, wherein the battery or cell is a non-gel lead-acid battery or cell or an absorptive glass mat (AGM) lead-acid battery or cell, comprising:
a positive electrode comprising a positive active material (PAM);
a negative electrode comprising a negative active material (NAM); and
a separator capable of immobilising an electrolyte disposed between the positive and negative electrodes,
the positive electrode and negative electrode each having a pore size diameter distribution measured by mercury porosimetry,
wherein the pore size diameter distribution of the positive and/or negative electrode comprises:
(a) a volume of pores having a pore size diameter greater than 10 μm of at least 0.070, 0.075, 0.080, 0.085, 0.090, 0.095, 0.100, 0.110, or 0.120 ml/g;
(b) a volume of pores having a pore size diameter greater than 15 μm of at least 0.035, 0.040, 0.050, 0.060, 0.070, 0.080, 0.090, or 0.095 ml/g;
(c) a volume of pores having a pore size diameter greater than 20 μm of at least 0.020, 0.025, 0.030, 0.035, 0.040, 0.045, 0.050, 0.055, 0.060, 0.065, 0.070, 0.075, 0.080, 0.085, 0.090, 0.095, or 0.100 ml/g;
(d) a volume of pores having a pore size diameter greater than 25 μm of at least 0.015, 0.020, 0.025, 0.030, 0.035, 0.040, or 0.050 ml/g;
(e) a volume of pores having a pore size diameter greater than 30 μm of at least 0.015, 0.020, 0.025, 0.030, 0.035, 0.040 ml/g;
(f) a volume of pores having a pore size diameter greater than 35 μm of at least 0.010, 0.015, 0.020, 0.025, or 0.030 ml/g; or
(g) any combination of two or more of (a) to (f).

In some embodiments of the above aspects, the battery or cell is a non-gel lead-acid battery or cell. In some embodiments of the above aspects, the battery or cell is an absorptive glass mat (AGM) lead-acid battery or cell.

In another aspect the present invention broadly consists in a non-gel lead-acid battery or cell comprising:
a positive electrode comprising a positive active material (PAM);
a negative electrode comprising a negative active material (NAM); and
a separator capable of immobilising an electrolyte disposed between the positive and negative electrodes,
the positive electrode and negative electrode each having a pore size diameter distribution measured by mercury porosimetry, and the separator having a pore size diameter distribution measured by capillary flow porometry,
wherein the pore size diameter distribution of the positive and/or negative electrode comprises a ratio of a volume of pores having a pore size diameter greater than 10 μm to a total pore volume of at least 50%.

In another aspect, the present invention broadly consists in a non-gel lead-acid battery or cell comprising:
a positive electrode comprising a positive active material (PAM);
a negative electrode comprising a negative active material (NAM); and
a separator capable of immobilising an electrolyte disposed between the positive and negative electrodes,
the positive electrode and negative electrode each having a pore size diameter distribution measured by mercury porosimetry, and the separator having a pore size diameter distribution measured by capillary flow porometry,
wherein the pore size diameter distribution of the positive and/or negative electrode comprises:
(a) a ratio of a volume of pores having a pore size diameter greater than 2 μm to a total pore volume of at least 85%;
(b) a ratio of a volume of pores having a pore size diameter greater than 3 μm to a total pore volume of at least 80%;
(c) a ratio of a volume of pores having a pore size diameter greater than 4 μm to a total pore volume of at least 75%;
(d) a ratio of a volume of pores having a pore size diameter greater than 5 μm to a total pore volume of at least 75%;
(e) a ratio of a volume of pores having a pore size diameter greater than 6 μm to a total pore volume of at least 70%;
(f) a ratio of a volume of pores having a pore size diameter greater than 7 μm to a total pore volume of at least 70%;
(g) a ratio of a volume of pores having a pore size diameter greater than 8 μm to a total pore volume of at least 65%;
(h) a ratio of a volume of pores having a pore size diameter greater than 9 μm to a total pore volume of at least 55%;
(i) a ratio of a volume of pores having a pore size diameter greater than 10 μm to a total pore volume of at least 50%; or
(l) any combination of two or more of (a) to (i).

In another aspect, the present invention broadly consists in a non-gel lead-acid battery or cell comprising:
a positive electrode comprising a positive active material (PAM);
a negative electrode comprising a negative active material (NAM); and
a separator capable of immobilising an electrolyte disposed between the positive and negative electrodes,
the positive electrode and negative electrode each having a pore size diameter distribution measured by mercury porosimetry, and the separator having a pore size diameter distribution measured by capillary flow porometry,
wherein the pore size diameter distribution of the positive and/or negative electrode comprises a ratio of a volume of pores having a pore size diameter greater than a mode pore size diameter of the separator disposed between the electrodes to a total pore volume of at least 80%.

In another aspect the present invention broadly consists in an absorptive glass mat (AGM) lead-acid battery or cell comprising:
a positive electrode comprising a positive active material (PAM);
a negative electrode comprising a negative active material (NAM); and
a separator capable of immobilising an electrolyte disposed between the positive and negative electrodes comprising, consisting essentially of, or consisting of an absorptive glass fibre mat,
the positive electrode and negative electrode each having a pore size diameter distribution measured by mercury porosimetry, and the separator having a pore size diameter distribution measured by capillary flow porometry,
wherein the pore size diameter distribution of the positive and/or negative electrode comprises a ratio of a volume of pores having a pore size diameter greater than 10 μm to a total pore volume of at least 50%.

In another aspect the present invention broadly consists in an absorptive glass mat (AGM) lead-acid battery or cell comprising:
a positive electrode comprising a positive active material (PAM);
a negative electrode comprising a negative active material (NAM); and
a separator capable of immobilising an electrolyte disposed between the positive and negative electrodes comprising, consisting essentially of, or consisting of an absorptive glass fibre mat,
the positive electrode and negative electrode each having a pore size diameter distribution measured by mercury porosimetry, and the separator having a pore size diameter distribution measured by capillary flow porometry,
wherein the pore size diameter distribution of the positive and/or negative electrode comprises:
(a) a ratio of a volume of pores having a pore size diameter greater than 2 μm to a total pore volume of at least 85%;
(b) a ratio of a volume of pores having a pore size diameter greater than 3 μm to a total pore volume of at least 80%;
(c) a ratio of a volume of pores having a pore size diameter greater than 4 μm to a total pore volume of at least 75%;
(d) a ratio of a volume of pores having a pore size diameter greater than 5 μm to a total pore volume of at least 75%;
(e) a ratio of a volume of pores having a pore size diameter greater than 6 μm to a total pore volume of at least 70%;
(f) a ratio of a volume of pores having a pore size diameter greater than 7 μm to a total pore volume of at least 70%;
(g) a ratio of a volume of pores having a pore size diameter greater than 8 μm to a total pore volume of at least 65%;
(h) a ratio of a volume of pores having a pore size diameter greater than 9 μm to a total pore volume of at least 55%;
(i) a ratio of a volume of pores having a pore size diameter greater than 10 μm to a total pore volume of at least 50%; or
(l) any combination of two or more of (a) to (i).

In another aspect, the present invention broadly consists in an absorptive glass mat (AGM) lead-acid battery or cell comprising:
a positive electrode comprising a positive active material (PAM);
a negative electrode comprising a negative active material (NAM); and
a separator capable of immobilising an electrolyte disposed between the positive and negative electrodes comprising, consisting essentially of, or consisting of an absorptive glass fibre mat,
the positive electrode and negative electrode each having a pore size diameter distribution measured by mercury porosimetry, and the separator having a pore size diameter distribution measured by capillary flow porometry,
wherein the pore size diameter distribution of the positive and/or negative electrode comprises a ratio of a volume of pores having a pore size diameter greater than a mode pore size diameter of the separator disposed between the electrodes to a total pore volume of at least 80%.

In another aspect the present invention broadly consists in an absorptive glass mat (AGM) lead-acid battery or cell comprising:
a positive electrode comprising a positive active material (PAM);
a negative electrode comprising a negative active material (NAM); and
a separator disposed between the positive and negative electrodes comprising, consisting essentially of, or consisting of an absorptive glass fibre mat,
the positive electrode and negative electrode each having a pore size diameter distribution measured by mercury porosimetry, and the separator having a pore size diameter distribution measured by capillary flow porometry,
wherein the pore size diameter distribution of the positive and/or negative electrode comprises a ratio of a volume of pores having a pore size diameter greater than 10 μm to a total pore volume of at least 50%.

In another aspect the present invention broadly consists in an absorptive glass mat (AGM) lead-acid battery or cell comprising:
a positive electrode comprising a positive active material (PAM);
a negative electrode comprising a negative active material (NAM); and
a separator disposed between the positive and negative electrodes comprising, consisting essentially of, or consisting of an absorptive glass fibre mat,
the positive electrode and negative electrode each having a pore size diameter distribution measured by mercury porosimetry, and the separator having a pore size diameter distribution measured by capillary flow porometry,
wherein the pore size diameter distribution of the positive and/or negative electrode comprises:
(a) a ratio of a volume of pores having a pore size diameter greater than 2 μm to a total pore volume of at least 85% or 90%;
(b) a ratio of a volume of pores having a pore size diameter greater than 3 μm to a total pore volume of at least 80% or 85%;
(c) a ratio of a volume of pores having a pore size diameter greater than 4 μm to a total pore volume of at least 75%, 80%, or 85%;
(d) a ratio of a volume of pores having a pore size diameter greater than 5 μm to a total pore volume of at least 75%, 80%, or 85%;
(e) a ratio of a volume of pores having a pore size diameter greater than 6 μm to a total pore volume of at least 70%, 75%, or 80%;
(f) a ratio of a volume of pores having a pore size diameter greater than 7 μm to a total pore volume of at least 70%, 75%, or 80%;
(g) a ratio of a volume of pores having a pore size diameter greater than 8 μm to a total pore volume of at least 65%, 70%, or 75%;
(h) a ratio of a volume of pores having a pore size diameter greater than 9 μm to a total pore volume of at least 55%, 60%, 65%, 70%, or 75%;
(i) a ratio of a volume of pores having a pore size diameter greater than 10 μm to a total pore volume of at least 50%, 55%, 60%, 65%, or 70%; or
(l) any combination of two or more of (a) to (i).

In another aspect, the present invention broadly consists in an absorptive glass mat (AGM) lead-acid battery or cell comprising:
a positive electrode comprising a positive active material (PAM);
a negative electrode comprising a negative active material (NAM); and
a separator disposed between the positive and negative electrodes comprising, consisting essentially of, or consisting of an absorptive glass fibre mat,
the positive electrode and negative electrode each having a pore size diameter distribution measured by mercury porosimetry, and the separator having a pore size diameter distribution measured by capillary flow porometry,
wherein the pore size diameter distribution of the positive and/or negative electrode comprises a ratio of a volume of pores having a pore size diameter greater than a mode pore size diameter of the separator disposed between the electrodes to a total pore volume of at least 80%.

The following embodiments and preferences may relate alone or in any combination of any two or more to any of the aspects above.

In various embodiments, if not already stated or stated otherwise, the battery or cell is a VRLA battery or cell.

In various embodiments, if not already stated or stated otherwise, the battery or cell is an absorptive glass mat (AGM) battery, wherein the separator comprises, consists essentially of, or consists of an absorptive glass fibre mat.

In various embodiments, the battery is a bipolar lead-acid battery.

In various embodiments, the battery is a bipolar lead-acid battery comprising:
one or more bipolar plate, each bipolar plate comprising
   an electrically conductive substrate,
   a positive electrode comprising a positive active material (PAM), and
   a negative electrode comprising a negative active material (NAM),
   wherein the positive electrode is located on a first surface of the electrically conductive substrate and the negative electrode located on a second surface of the electrically conductive substrate opposite the first surface;
a positive end comprising a positive electrode optionally comprising a positive active material (PAM);
a negative end comprising a negative electrode optionally comprising a negative active material (NAM); and
separators disposed between each negative electrode and positive electrode;
the positive electrodes and negative electrodes each having a pore size diameter distribution measured by mercury porosimetry, and the separators each having a pore size diameter distribution measured by capillary flow porometry,
wherein the battery comprises at least one cell wherein the pore size diameter distribution of the positive and/or negative electrode is as defined in any of the aspects above.

In various embodiments, the bipolar lead-acid battery comprises at least one cell wherein the pore size diameter distribution as defined in any of the aspects above is of the positive electrode of the bipolar plate and/or the negative electrode of the bipolar plate.

In various embodiments, the bipolar battery comprises two or more bipolar plates. In various embodiments, the bipolar battery comprises a stack of bipolar plates.

In various embodiments, if not already stated or stated otherwise, the separator has a pore size diameter distribution measured by capillary flow porometry, wherein the pore size diameter distribution of the positive and/or negative electrode comprises a ratio of the volume of pores greater than the mode pore size diameter of the separator to the total pore volume of at least 80%, or 85%.

In various embodiments, the separator has a pore size diameter distribution measured by capillary flow porometry, wherein the pore size diameter distribution of the positive and/or negative electrode comprises a ratio of the volume of pores greater than the mode pore size diameter of the separator to the total pore volume of at least 85%.

In various embodiments, the separator has a pore size diameter distribution measured by capillary flow porometry, wherein the separator has a mode pore size diameter less than or equal to about 20 μm, 18 μm, 16 μm, 15 μm, 14 μm, 13 μm, 12 μm, 11 μm, or 10 μm. In certain embodiments, the separator has a mode pore size diameter less than or equal to about 10 μm, for example less than or equal to 9 μm, 8 μm, 7 μm, 6 μm, or 5 μm. In certain embodiments, the separator has a mode pore size diameter less than or equal to about 5 μm, for example less than or equal to 4 μm, 3 μm, 2 μm, or 1 μm.

In various embodiments, the separator has a pore size diameter distribution measured by capillary flow porometry, wherein the separator has a mode pore size diameter from about 1 to 20 μm, 1 to 18 μm, 1 to 16 μm, 1 to 15 μm, 1 to 14 μm, 1 to 13 μm, 1 to 12 μm, 1 to 11 μm, 1 to 10 μm, 1 to 9 μm, 1 to 8 μm, 1 to 7 μm, 1 to 6 μm, 1 to 5 μm, 2 to 20 μm, 2 to 18 μm, 2 to 16 μm, 2 to 15 μm, 2 to 14 μm, 2 to 13 μm, 2 to 12 μm, 2 to 11 μm, 2 to 10 μm, 2 to 9 μm, 2 to 8 μm, 2 to 7 μm, 2 to 6 μm, 2 to 5 μm, 3 to 20 μm, 3 to 18 μm, 3 to 16 μm, 3 to 15 μm, 3 to 14 μm, 3 to 13 μm, 3 to 12 μm, 3 to 11 μm, 3 to 10 μm, 3 to 9 μm, 3 to 8 μm, 3 to 7 μm, 3 to 6 μm, 3 to 5 μm, 4 to 20 μm, 4 to 18 μm, 4 to 16 μm, 4 to 15 μm, 4 to 14 μm, 4 to 13 μm, 4 to 12 μm, 4 to 11 μm, 4 to 10 μm. 4 to 9 μm, 4 to 8 μm, 4 to 7 μm, 4 to 6 μm, 4 to 5 μm, 5 to 20 μm, 5 to 18 μm, 5 to 16 μm, 5 to 15 μm, 5 to 14 μm, 5 to 13 μm, 5 to 12 μm, 5 to 11 μm, 5 to 10 μm. 5 to 9 μm, 5 to 8 μm, 5 to 7 μm, or 5 to 6 μm. In certain embodiments, the separator has a mode pore size diameter from about 1 to 10 μm, for example 2 to 10 μm or 4 to 6 μm.

In various embodiments, the positive and/or negative electrode is formed from a paste which at impregnation has a density of from about 1.5 to 5.5 g/cm³. In various embodiments, the positive and/or negative electrode is formed from a paste which at impregnation has a density of from about 1.5 to 5 g/cm³.

In various embodiments, at least the negative electrode comprises said pore size diameter distribution.

In another aspect, the present invention broadly consists in an electrode for a lead-acid battery or cell comprising an active material and having a pore size diameter distribution measured by mercury porosimetry, wherein the pore size diameter distribution comprises a ratio of a volume of pores having a pore size diameter greater than 20 μm to a total pore volume of at least 15%.

In another aspect, the present invention broadly consists in an electrode for a lead-acid battery or cell comprising an active material and having a pore size diameter distribution measured by mercury porosimetry, wherein the pore size diameter distribution of the positive and/or negative electrode comprises a volume of pores having a pore size diameter greater than 20 μm of at least 0.020 ml/g.

In another aspect, the present invention broadly consists in an electrode for a lead-acid battery or cell comprising an active material and having a pore size diameter distribution measured by mercury porosimetry, wherein the pore size diameter distribution comprises:
(a) a ratio of a volume of pores having a pore size diameter greater than 10 μm to a total pore volume of at least 50%, 55%, 60%, 65%, or 70%;
(b) a ratio of a volume of pores having a pore size diameter greater than 15 μm to a total pore volume of at least 25%, 30%, 35%, 40%, 45%, 50%, or 55%;
(c) a ratio of a volume of pores having a pore size diameter greater than 20 μm to a total pore volume of at least 15%, 20%, 25%, 30%, 40%, or 45%;
(d) a ratio of a volume of pores having a pore size diameter greater than 25 μm to a total pore volume of at least 15%, 20%, 25% or 30%;
(e) a ratio of a volume of pores having a pore size diameter greater than 30 μm to a total pore volume of at least 10%, 15%, 20%, or 25%;
(f) a ratio of a volume of pores having a pore size diameter greater than 35 μm to a total pore volume of at least 10%, 15%, or 20%; or
(g) any combination of two or more of (a) to (f).

In another aspect, the present invention broadly consists in an electrode for a lead-acid battery or cell comprising an active material and having a pore size diameter distribution measured by mercury porosimetry, wherein the pore size diameter distribution comprises:
(a) a volume of pores having a pore size diameter greater than 10 μm of at least 0.070, 0.075, 0.080, 0.085, 0.090, 0.095, 0.100, 0.110, or 0.120 ml/g;
(b) a volume of pores having a pore size diameter greater than 15 μm of at least 0.035, 0.040, 0.050, 0.060, 0.070, 0.080, 0.090, or 0.095 ml/g;
(c) a volume of pores having a pore size diameter greater than 20 μm of at least 0.020, 0.025, 0.030, 0.035, 0.040, 0.045, 0.050, 0.055, 0.060, 0.065, 0.070, 0.075, 0.080, 0.085, 0.090, 0.095, or 0.100 ml/g;
(d) a volume of pores having a pore size diameter greater than 25 μm of at least 0.015, 0.020, 0.025, 0.030, 0.035, 0.040, or 0.050 ml/g;
(e) a volume of pores having a pore size diameter greater than 30 μm of at least 0.015, 0.020, 0.025, 0.030, 0.035, 0.040 ml/g;
(f) a volume of pores having a pore size diameter greater than 35 μm of at least 0.010, 0.015, 0.020, 0.025, or 0.030 ml/g; or
(g) any combination of two or more of (a) to (f).

In another aspect, the present invention broadly consists in an electrode for a lead-acid battery or cell comprising an active material and having a pore size diameter distribution measured by mercury porosimetry, wherein the pore size diameter distribution comprises a ratio of a volume of pores having a pore size diameter greater than 10 μm to a total pore volume of at least 50%.

In various embodiments, the electrode is a negative electrode.

In various embodiments, the electrode is formed from a paste which at impregnation has a density of from about 1.5 to 5.5 g/cm³. In various embodiments, the electrode is formed from a paste which at impregnation has a density of from about 1.5 to 5 g/cm³.

In another aspect, the present invention broadly consists in an electrode for a lead-acid battery or cell comprising an active material and having a pore size diameter distribution measured by mercury porosimetry, wherein the pore size diameter distribution comprises:
(a) a ratio of a volume of pores having a pore size diameter greater than 2 μm to a total pore volume of at least 85%;
(b) a ratio of a volume of pores having a pore size diameter greater than 3 μm to a total pore volume of at least 80%;
(c) a ratio of a volume of pores having a pore size diameter greater than 4 μm to a total pore volume of at least 75%;
(d) a ratio of a volume of pores having a pore size diameter greater than 5 μm to a total pore volume of at least 75%;
(e) a ratio of a volume of pores having a pore size diameter greater than 6 μm to a total pore volume of at least 70%;
(f) a ratio of a volume of pores having a pore size diameter greater than 7 μm to a total pore volume of at least 70%;
(g) a ratio of a volume of pores having a pore size diameter greater than 8 μm to a total pore volume of at least 65%;
(h) a ratio of a volume of pores having a pore size diameter greater than 9 μm to a total pore volume of at least 55%;
(i) a ratio of a volume of pores having a pore size diameter greater than 10 μm to a total pore volume of at least 50%; or
(l) any combination of two or more of (a) to (i).

In various embodiments, the electrode is a negative electrode.

In various embodiments, the electrode is formed from a paste which at impregnation has a density of from about 1.5 to 5.5 g/cm³. In various embodiments, the electrode is formed from a paste which at impregnation has a density of from about 1.5 to 5 g/cm³.

The following embodiments and preferences may relate alone or in any combination of any two or more to any of the aspects above.

In various embodiments, the pore size diameter distribution comprises:
(a) a ratio of a volume of pores having a pore size diameter greater than 10 μm to a total pore volume of at least 50%, 55%, 60%, 65%, or 70%;
(b) a ratio of a volume of pores having a pore size diameter greater than 20 μm to a total pore volume of at least 15%, 20%, 25%, 30%, 40%, or 45%; and
(c) a ratio of a volume of pores having a pore size diameter greater than 30 μm to a total pore volume of at least 10%, 15%, 20%, or 25%.

In various embodiments, the pore size diameter distribution comprises:
(a) a ratio of a volume of pores having a pore size diameter greater than 20 μm to a total pore volume of at least 15%, 20%, 25%, 30%, 40%, or 45%; and
(b) a ratio of a volume of pores having a pore size diameter greater than 30 μm to a total pore volume of at least 10%, 15%, 20%, or 25%.

In various embodiments, the pore size diameter distribution comprises:
(a) a ratio of a volume of pores having a pore size diameter greater than 20 μm to a total pore volume of at least 15%, 20%, 25%, 30%, 40%, or 45%;
(b) a ratio of a volume of pores having a pore size diameter greater than 25 μm to a total pore volume of at least 15%, 20%, 25% or 30%; and
(c) a ratio of a volume of pores having a pore size diameter greater than 30 μm to a total pore volume of at least 10%, 15%, 20%, or 25%;

In various embodiments, the pore size diameter distribution comprises:
(a) a volume of pores having a pore size diameter greater than 10 μm of at least 0.070, 0.075, 0.080, 0.085, 0.090, 0.095, 0.100, 0.110, or 0.120 ml/g;
(b) a volume of pores having a pore size diameter greater than 20 μm of at least 0.020, 0.025, 0.030, 0.035, 0.040, 0.045, 0.050, 0.055, 0.060, 0.065, 0.070, 0.075, 0.080, 0.085, 0.090, 0.095, or 0.100 ml/g; and
(c) a volume of pores having a pore size diameter greater than 30 μm of at least 0.015, 0.020, 0.025, 0.030, 0.035, 0.040 ml/g.

In various embodiments, the pore size diameter distribution comprises:
(a) a volume of pores having a pore size diameter greater than 20 μm of at least 0.020, 0.025, 0.030, 0.035, 0.040, 0.045, 0.050, 0.055, 0.060, 0.065, 0.070, 0.075, 0.080, 0.085, 0.090, 0.095, or 0.100 ml/g; and
(b) a volume of pores having a pore size diameter greater than 30 μm of at least 0.015, 0.020, 0.025, 0.030, 0.035, 0.040 ml/g.

In various embodiments, the pore size diameter distribution comprises:
(a) a volume of pores having a pore size diameter greater than 20 μm of at least 0.020, 0.025, 0.030, 0.035, 0.040, 0.045, 0.050, 0.055, 0.060, 0.065, 0.070, 0.075, 0.080, 0.085, 0.090, 0.095, or 0.100 ml/g;
(b) a volume of pores having a pore size diameter greater than 25 μm of at least 0.015, 0.020, 0.025, 0.030, 0.035, 0.040, or 0.050 ml/g; and
(c) a volume of pores having a pore size diameter greater than 30 μm of at least 0.015, 0.020, 0.025, 0.030, 0.035, 0.040 ml/g.

In various embodiments, if not already stated or stated otherwise, the pore size diameter distribution of the electrode or of the positive and/or negative electrode comprises a ratio of a volume of pores having a pore size diameter greater than 20 μm to a total pore volume of at least 15%, 20%, 25%, 30%, 40%, or 45%. In various embodiments, the pore size diameter distribution of the electrode or of the positive and/or negative electrode comprises a ratio of a volume of pores having a pore size diameter greater than 20 μm to a total pore volume of at least 20%, 25%, 30%, 40%, or 45%. In various embodiments, the pore size diameter distribution of the electrode or of the positive and/or negative electrode comprises a ratio of a volume of pores having a pore size diameter greater than 20 μm to a total pore volume of at least 30%, 40%, or 45%.

In various embodiments, the pore size diameter distribution of the electrode or of the positive and/or negative electrode comprises a volume of pores having a pore size diameter greater than 20 μm of at least 0.020, 0.025, 0.030, 0.035, 0.040, 0.045, 0.050, 0.055, 0.060, 0.065, 0.070, 0.075, 0.080, 0.085, 0.090, 0.095, or 0.100 ml/g. In various embodiments, the pore size diameter distribution of the electrode or of the positive and/or negative electrode comprises a volume of pores having a pore size diameter greater than 20 μm of at least 0.030, 0.035, 0.040, 0.045, 0.050, 0.055, 0.060, 0.065, 0.070, 0.075, 0.080, 0.085, 0.090, 0.095, or 0.100 ml/g. In various embodiments, the pore size diameter distribution of the electrode or of the positive and/or negative electrode comprises a volume of pores having a pore size diameter greater than 20 μm of at least 0.040, 0.045, 0.050, 0.055, 0.060, 0.065, 0.070, 0.075, 0.080, 0.085, 0.090, 0.095, or 0.100 ml/g.

In various embodiments, the pore size diameter distribution of the electrode or of the positive and/or negative electrode comprises a total pore volume of at least about 0.135, 0.140, 0.145, 0.150, 0.155, 0.160, 0.165, 0.170, 0.175, 0.180, 0.185, 0.190, 0.195, or 0.200 ml/g. In various embodiments, the pore size diameter distribution of the electrode or of the positive and/or negative electrode comprises a total pore volume of at least about 0.150, 0.155, 0.160, 0.165, 0.170, 0.175, 0.180, 0.185, 0.190, 0.195, or 0.200 ml/g.

In various embodiments, the electrode or the positive and/or negative electrode having said pore size distribution is formed from a paste having a leady oxide content not greater than 85% or not greater than 84%.

In various embodiments, if not already stated or stated otherwise, the pore size diameter distribution of the electrode of the invention or of the positive and/or negative electrode of the battery or cell of the invention comprises a ratio of a volume of pores having a pore size diameter greater than 10 μm to a total pore volume of at least 25%, for example at least 50%, 55%, 60%, 65%, or 70%.

In various embodiments, the pore size diameter distribution of the electrode or of the positive and/or negative electrode comprises a volume of pores having a pore size diameter greater than 10 μm of at least 0.070, 0.075, 0.080, 0.085, 0.090, 0.095, 0.100, 0.110, or 0.120 ml/g. In various embodiments, the pore size diameter distribution of the electrode or of the positive and/or negative electrode comprises a volume of pores having a pore size diameter greater than 10 μm of at least 0.070, 0.075, 0.080, 0.085, 0.090, 0.095, 0.100, 0.110, or 0.120 ml/g.

In various embodiments, the pore size diameter distribution of the electrode or of the electrode or of the positive and/or negative electrode comprises a ratio of a volume of pores having a pore size diameter greater than 15 μm to a total pore volume of at least 25%, 30%, 35%, 40%, 45%, 50%, or 55%. In various embodiments, the pore size diameter distribution of the electrode or of the electrode or of the positive and/or negative electrode comprises a ratio of a volume of pores having a pore size diameter greater than 15 μm to a total pore volume of at least 45%, 50%, or 55%.

In various embodiments, the pore size diameter distribution of the electrode or of the positive and/or negative electrode comprises a volume of pores having a pore size diameter greater than 15 μm of at least 0.035, 0.040, 0.050, 0.060, 0.070, 0.080, 0.090, or 0.095 ml/g. In various embodiments, the pore size diameter distribution of the electrode or of the positive and/or negative electrode comprises a volume of pores having a pore size diameter greater than 15 μm of at least 0.070, 0.080, 0.090, or 0.095 ml/g.

In various embodiments, the pore size diameter distribution of the electrode or of the electrode or of the positive and/or negative electrode comprises a ratio of a volume of pores having a pore size diameter greater than 25 μm to a total pore volume of at least 15%, 20%, 25% or 30%. In various embodiments, the pore size diameter distribution of the electrode or of the electrode or of the positive and/or negative electrode comprises a ratio of a volume of pores having a pore size diameter greater than 25 μm to a total pore volume of at least 20%, 25% or 30%.

In various embodiments, the pore size diameter distribution of the electrode or of the positive and/or negative electrode comprises a volume of pores having a pore size diameter greater than 25 μm of at least 0.015, 0.020, 0.025, 0.030, 0.035, 0.040, or 0.050 ml/g. In various embodiments, the pore size diameter distribution of the electrode or of the positive and/or negative electrode comprises a volume of pores having a pore size diameter greater than 25 μm of at least 0.025, 0.030, 0.035, 0.040, or 0.050 ml/g.

In various embodiments, the pore size diameter distribution of the electrode or of the electrode or of the positive and/or negative electrode comprises a ratio of a volume of pores having a pore size diameter greater than 30 μm to a total pore volume of at least 10%, 15%, 20%, or 25%. In various embodiments, the pore size diameter distribution of the electrode or of the electrode or of the positive and/or negative electrode comprises a ratio of a volume of pores having a pore size diameter greater than 30 μm to a total pore volume of at least 15%, 20%, or 25%.

In various embodiments, the pore size diameter distribution of the electrode or of the positive and/or negative electrode comprises a volume of pores having a pore size diameter greater than 30 μm of at least 0.015, 0.020, 0.025, 0.030, 0.035, 0.040 ml/g. In various embodiments, the pore size diameter distribution of the electrode or of the positive and/or negative electrode comprises a volume of pores having a pore size diameter greater than 30 μm of at least 0.020, 0.025, 0.030, 0.035, 0.040 ml/g.

In various embodiments, the pore size diameter distribution of the electrode or of the electrode or of the positive and/or negative electrode comprises a ratio of a volume of pores having a pore size diameter greater than 35 μm to a total pore volume of at least 10%, 15%, or 20%.

In various embodiments, the pore size diameter distribution of the electrode or of the positive and/or negative electrode comprises a volume of pores having a pore size diameter greater than 35 μm of at least 0.010, 0.015, 0.020, 0.025, or 0.030 ml/g. In various embodiments, the pore size diameter distribution of the electrode or of the positive and/or negative electrode comprises a volume of pores having a pore size diameter greater than 35 μm of at least 0.015, 0.020, 0.025, or 0.030 ml/g.

In various embodiments, the pore size diameter distribution of the electrode of the invention or of the positive and/or negative electrode of the battery or cell of the invention comprises a ratio of a volume of pores having a pore size diameter greater than 5 μm to a total pore volume of at least 75%, 80%, or 85%; and optionally
(a) a ratio of a volume of pores having a pore size diameter greater than 2 μm to a total pore volume of at least 85% or 90%;
(b) a ratio of a volume of pores having a pore size diameter greater than 3 μm to a total pore volume of at least 80% or 85%;
(c) a ratio of a volume of pores having a pore size diameter greater than 4 μm to a total pore volume of at least 75%, 80%, or 85%;
(d) a ratio of a volume of pores having a pore size diameter greater than 6 μm to a total pore volume of at least 70%, 75%, or 80%;
(e) a ratio of a volume of pores having a pore size diameter greater than 7 μm to a total pore volume of at least 70%, 75%, or 80%;
(f) a ratio of a volume of pores having a pore size diameter greater than 8 μm to a total pore volume of at least 65%, 70%, or 75%;
(g) a ratio of a volume of pores having a pore size diameter greater than 9 μm to a total pore volume of at least 55%, 60%, 65%, 70%, or 75%;
(h) a ratio of a volume of pores having a pore size diameter greater than 10 μm to a total pore volume of at least 50%, 55%, 60%, 65%, or 70%; or
(i) any combination of two or more of (a) to (h).

In various embodiments, the pore size diameter distribution of the electrode of the invention or of the positive and/or negative electrode of the battery or cell of the invention comprises a ratio of a volume of pores having a pore size diameter greater than 10 μm to a total pore volume of at least 50%, 55%, 60%, 65%, or 70%; and
(a) a ratio of a volume of pores having a pore size diameter greater than 2 μm to a total pore volume of at least 85% or 90%;
(b) a ratio of a volume of pores having a pore size diameter greater than 3 μm to a total pore volume of at least 80% or 85%;
(c) a ratio of a volume of pores having a pore size diameter greater than 4 μm to a total pore volume of at least 75%, 80%, or 85%;
(d) a ratio of a volume of pores having a pore size diameter greater than 5 μm to a total pore volume of at least 75%, 80%, or 85%;
(e) a ratio of a volume of pores having a pore size diameter greater than 6 μm to a total pore volume of at least 70%, 75%, or 80%;
(f) a ratio of a volume of pores having a pore size diameter greater than 7 μm to a total pore volume of at least 70%, 75%, or 80%;
(g) a ratio of a volume of pores having a pore size diameter greater than 8 μm to a total pore volume of at least 65%, 70%, or 75%;
(h) a ratio of a volume of pores having a pore size diameter greater than 9 μm to a total pore volume of at least 55%, 60%, 65%, 70%, or 75%; or
(i) any combination of two or more of (a) to (h)

In various embodiments, the pore size diameter distribution of the electrode of the invention or of the positive and/or negative electrode of the battery or cell of the invention comprises a ratio of the volume of pores greater than 10 μm to the total pore volume of at least 55%, 60%, 65%, or 70%. In various embodiments, the pore size diameter distribution of the electrode or of the electrode or of the positive and/or negative electrode comprises a ratio of the volume of pores greater than 10 μm to the total pore volume of at least 65% or 70%.

In various embodiments, the pore size diameter distribution of the electrode of the invention or of the positive and/or negative electrode of the battery or cell of the invention comprises a ratio of a volume of pores having a pore size diameter greater than 1 μm to a total pore volume of at least 95%.

In various embodiments, the pore size diameter distribution of the electrode of the invention or of the positive and/or negative electrode of the battery or cell of the invention comprises a ratio of a volume of pores having a pore size diameter greater than 2 μm to a total pore volume of at least 85% or 90%.

In various embodiments, the pore size diameter distribution of the electrode of the invention or of the positive and/or negative electrode of the battery or cell of the invention comprises a ratio of a volume of pores having a pore size diameter greater than 3 μm to a total pore volume of at least 80% or 85%.

In various embodiments, the pore size diameter distribution of the electrode of the invention or of the positive and/or negative electrode of the battery or cell of the invention comprises a ratio of a volume of pores having a pore size diameter greater than 4 μm to a total pore volume of at least 75%, 80%, or 85%.

In various embodiments, the pore size diameter distribution of the electrode of the invention or of the positive and/or negative electrode of the battery or cell of the invention comprises a ratio of a volume of pores having a pore size diameter greater than 5 μm to a total pore volume of at least 75%, 80%, or 85%.

In various embodiments, the pore size diameter distribution of the electrode of the invention or of the positive and/or negative electrode of the battery or cell of the invention comprises a ratio of a volume of pores having a pore size diameter greater than 6 μm to a total pore volume of at least 70%, 75%, or 80%.

In various embodiments, the pore size diameter distribution of the electrode of the invention or of the positive and/or negative electrode of the battery or cell of the invention comprises a ratio of a volume of pores having a pore size diameter greater than 7 μm to a total pore volume of at least 70%, 75%, or 80%.

In various embodiments, the pore size diameter distribution of the electrode of the invention or of the positive and/or negative electrode of the battery or cell of the invention comprises a ratio of a volume of pores having a pore size diameter greater than 8 μm to a total pore volume of at least 65%, 70%, or 75%.

In various embodiments, the pore size diameter distribution of the electrode of the invention or of the positive and/or negative electrode of the battery or cell of the invention comprises a ratio of a volume of pores having a pore size diameter greater than 9 μm to a total pore volume of at least 55%, 60%, 65%, 70%, or 75%.

In various embodiments, the pore size diameter distribution of the electrode of the invention or of the positive and/or negative electrode of the battery or cell of the invention comprises:
(a) a ratio of a volume of pores having a pore size diameter greater than 3 μm to a total pore volume of at least 80% or 85%;
(b) a ratio of a volume of pores having a pore size diameter greater than 5 μm to a total pore volume of at least 75%, 80%, or 85%;
(c) a ratio of a volume of pores having a pore size diameter greater than 7 μm to a total pore volume of at least 70%, 75%, or 80%; and
(d) a ratio of a volume of pores having a pore size diameter greater than 10 μm to a total pore volume of at least 50%, 55%, 60%, 65%, or 70%.

In various embodiments, the pore size diameter distribution of the electrode of the invention or of the positive and/or negative electrode of the battery or cell of the invention comprises:
(a) a ratio of a volume of pores having a pore size diameter greater than 3 μm to a total pore volume of at least 85%;
(b) a ratio of a volume of pores having a pore size diameter greater than 5 μm to a total pore volume of at least 80%, or 85%;
(c) a ratio of a volume of pores having a pore size diameter greater than 7 μm to a total pore volume of at least 75%, or 80%; and
(d) a ratio of a volume of pores having a pore size diameter greater than 10 μm to a total pore volume of at least 55%, 60%, 65%, or 70%.

In various embodiments, the pore size diameter distribution of the electrode of the invention or of the positive and/or negative electrode of the battery or cell of the invention comprises:
(a) a ratio of a volume of pores having a pore size diameter greater than 5 μm to a total pore volume of at least 75%, 80%, or 85%; and
(b) a ratio of a volume of pores having a pore size diameter greater than 10 μm to a total pore volume of at least 50%, 55%, 60%, 65%, or 70%.

In various embodiments, the pore size diameter distribution of the electrode of the invention or of the positive and/or negative electrode of the battery or cell of the invention comprises:
(a) a ratio of a volume of pores having a pore size diameter greater than 5 μm to a total pore volume of at least 80%, or 85%; and
(b) a ratio of a volume of pores having a pore size diameter greater than 10 μm to a total pore volume of at least 55%, 60%, 65%, or 70%.

In various embodiments, the pore size diameter distribution of the electrode of the invention or of the positive and/or negative electrode of the battery or cell of the invention comprises:
(a) a ratio of a volume of pores having a pore size diameter greater than 5 μm to a total pore volume of at least 85%; and
(b) a ratio of a volume of pores having a pore size diameter greater than 10 μm to a total pore volume of at least 60%, 65%, or 70%.

In various embodiments, the pore size diameter distribution of the electrode of the invention or of the positive and/or negative electrode of the battery or cell of the invention comprises:
(a) a ratio of a volume of pores having a pore size diameter greater than 5 μm to a total pore volume of at least 85%; and
(b) a ratio of a volume of pores having a pore size diameter greater than 10 μm to a total pore volume of at least 65% or 70%.

In various embodiments, the pore size diameter distribution of the electrode of the invention or of the positive and/or negative electrode of the battery or cell of the invention comprises:
(a) a ratio of a volume of pores having a pore size diameter greater than 5 μm to a total pore volume of at least 75%, 80%, or 85%; and
(b) a ratio of a volume of pores having a pore size diameter greater than 10 μm to a total pore volume of at least 50%, 55%, 60%, 65%, or 70%.

In various embodiments, the pore size diameter distribution of the electrode of the invention or of the positive and/or negative electrode of the battery or cell of the invention comprises:
(a) a ratio of a volume of pores having a pore size diameter greater than 5 μm to a total pore volume of at least 80% or 85%; and
(b) a ratio of a volume of pores having a pore size diameter greater than 10 μm to a total pore volume of at least 55%, 60%, 65%, or 70%.

In various embodiments, the pore size diameter distribution of the electrode of the invention or of the positive and/or negative electrode of the battery or cell of the invention comprises:
(a) a ratio of a volume of pores having a pore size diameter greater than 5 μm to a total pore volume of at least 85%; and
(b) a ratio of a volume of pores having a pore size diameter greater than 10 μm to a total pore volume of at least 60%, 65%, or 70%.

In various embodiments, the pore size diameter distribution of the electrode of the invention or of the positive and/or negative electrode of the battery or cell of the invention comprises:
(a) a ratio of a volume of pores having a pore size diameter greater than 3 μm to a total pore volume of at least 80% or 85%;
(b) a ratio of a volume of pores having a pore size diameter greater than 5 μm to a total pore volume of at least 75%, 80%, or 85%;
(c) a ratio of a volume of pores having a pore size diameter greater than 7 μm to a total pore volume of at least 70%, 75%, or 80%; and
(d) a ratio of a volume of pores having a pore size diameter greater than 10 μm to a total pore volume of at least 50%, 55%, 60%, 65%, or 70%.

In various embodiments, the pore size diameter distribution of the electrode of the invention or of the positive and/or negative electrode of the battery or cell of the invention comprises:
(a) a ratio of a volume of pores having a pore size diameter greater than 3 μm to a total pore volume of at least 85%;
(b) a ratio of a volume of pores having a pore size diameter greater than 5 μm to a total pore volume of at least 80%, or 85%;
(c) a ratio of a volume of pores having a pore size diameter greater than 7 μm to a total pore volume of at least 75%, or 80%; and
(d) a ratio of a volume of pores having a pore size diameter greater than 10 μm to a total pore volume of at least 55%, 60%, 65%, or 70%.

In various embodiments, the pore size diameter distribution of the electrode of the invention or of the positive and/or negative electrode of the battery or cell of the invention comprises:
(a) a ratio of a volume of pores having a pore size diameter greater than 3 μm to a total pore volume of at least 80% or 85%;
(b) a ratio of a volume of pores having a pore size diameter greater than 5 μm to a total pore volume of at least 75%, 80%, or 85%;
(c) a ratio of a volume of pores having a pore size diameter greater than 10 μm to a total pore volume of at least 50%, 55%, 60%, 65%, or 70%.

In various embodiments, the pore size diameter distribution of the electrode of the invention or of the positive and/or negative electrode of the battery or cell of the invention comprises:
(a) a ratio of a volume of pores having a pore size diameter greater than 3 μm to a total pore volume of at least 85%;
(b) a ratio of a volume of pores having a pore size diameter greater than 5 μm to a total pore volume of at least 80% or 85%;
(c) a ratio of a volume of pores having a pore size diameter greater than 10 μm to a total pore volume of at least 55%, 60%, 65%, or 70%.

In various embodiments, the pore size diameter distribution of the electrode of the invention or of the positive and/or negative electrode of the battery or cell of the invention comprises:
(a) a ratio of a volume of pores having a pore size diameter greater than 3 μm to a total pore volume of at least 85%;
(b) a ratio of a volume of pores having a pore size diameter greater than 5 μm to a total pore volume of at least 85%;
(c) a ratio of a volume of pores having a pore size diameter greater than 10 μm to a total pore volume of at least 60%, 65%, or 70%.

In various embodiments, the pore size diameter distribution of the electrode of the invention or of the positive and/or negative electrode of the battery or cell of the invention comprises:
(a) a ratio of a volume of pores having a pore size diameter greater than 3 μm to a total pore volume of at least 85%;
(b) a ratio of a volume of pores having a pore size diameter greater than 5 μm to a total pore volume of at least 85%;
(c) a ratio of a volume of pores having a pore size diameter greater than 10 μm to a total pore volume of at least 65%, or 70%.

In another aspect, the present invention broadly consists in a bipolar plate for a bipolar lead-acid battery comprising an electrically conductive substrate, a positive electrode comprising a positive active material (PAM), and a negative electrode comprising a negative active material (NAM),
wherein the positive electrode is located on a first surface of the electrically conductive substrate and the negative electrode located on a second surface of the electrically conductive substrate opposite the first surface; and wherein the positive and/or negative electrode is an electrode of the present invention.

The following embodiments and preferences may relate alone or in any combination of any two or more to any of the aspects above.

In various embodiments, the positive and/or negative electrode comprises an electrode framework in which the active material is disposed.

In various embodiments, the electrode framework comprises a fibrous material.

In various embodiments, the fibrous material has an average interfibre spacing of less than about 250 μm.

In various embodiments, the fibrous material has a bulk density of wherein the fibrous material has a bulk density of about 0.05 g/cm³ to 0.2 g/cm³, 0.07 to 0.17 g/cm³, or 0.08 to 0.15 g/cm³.

In another aspect, the present invention broadly consists in a method of manufacturing a lead-acid battery or cell of the present invention, the method comprising:
providing a positive electrode comprising a positive active material oxide (PAM oxide) paste,
a negative electrode comprising a negative active material oxide (NAM oxide) paste, and a separator capable of immobilising an electrolyte;
assembling the battery or cell from the positive electrode, negative electrode, and separator; adding an electrolyte; and
subjecting the battery or cell to an initial cell or battery charge for cell formation.

In various embodiments, providing the at least one positive electrode and/or at least one negative electrode comprises applying to an electrode framework a positive active material oxide (PAM oxide) paste or a negative active material oxide (NAM oxide) paste.

In various embodiments the paste is applied to the electrode framework within a confined pasting zone.

In various embodiments, the paste at impregnation has a density of from about 1.5 to 5.5 g/cm³. In various embodiments, the paste at impregnation has a density of from about 1.5 to 5 g/cm³.

In another aspect, the present invention broadly consists in a method of manufacturing an electrode of the present invention, the method comprising applying to an electrode framework a positive active material oxide (PAM oxide) paste or a negative active material oxide (NAM oxide) paste.

In various embodiments the paste is applied to the electrode framework within a confined pasting zone.

In various embodiments, the paste at impregnation has a density of from about 1.5 to 5.5 g/cm³. In various embodiments, the paste at impregnation has a density of from about 1.5 to 5 g/cm³.

In another aspect, the present invention broadly consists in a method of manufacturing a bipolar plate of the present invention, the method comprising providing an electrode of the present invention on a first surface of an electrically conductive substrate and providing an electrode of opposite polarity on a second surface of the electrically conductive substrate opposite the first surface.

### Definitions

The term “comprising” means “consisting at least in part of”. When interpreting each statement in this specification that includes the term “comprising”, features other than that or those prefaced by the term may also be present. Related terms such as “comprise” and “comprises” are to be interpreted in the same manner.

The term “non-gel lead-acid battery or cell” and similar terms such as “non-gel lead-acid battery” means a lead-acid battery or cell comprising electrolyte that is not immobilised in a gel. In some embodiments, a non-gel lead-acid battery or cell comprises no gelling agent. In other embodiments, a non-gel lead-acid battery or cell comprises a gelling agent in the electrolyte in an amount that is insufficient to produce a gel capable of immobilising the electrolyte. In some embodiments, a non-gel lead-acid battery or cell comprises a portion of electrolyte that is immobilised in a gel and a portion of electrolyte that is not immobilised in a gel. For example, in some embodiments, a non-gel lead-acid battery or cell comprises a gelled top blanket. In such embodiments, preferably, a major portion of the electrolyte of the battery or cell (for example at least 50%, 60%, 70%, 80%, 90%, 95%, or 100%) is not immobilised in a gel.

Unless otherwise stated, the singular forms “a,” “an,” and “the” include the plural reference.

As used herein the term “and/or” means “and” or “or”, or both.

As used herein “(s)” following a noun means the plural and/or singular forms of the noun.

Unless indicated otherwise, all percentages, parts, ratios, etc., are by weight.

The term “negative active material” (or “NAM”) as used herein, unless indicated otherwise, refers to the non-grid lead active material within and/or on a negative electrode in the formed and fully charged (100% SOC) state.

The term “positive active material” (or “PAM”) as used herein, unless indicated otherwise, refers to the lead dioxide active material within and/or on a positive electrode in the formed and fully charged (100% SOC) state.

The term “negative active material oxide” (or “NAM oxide”) as used herein, unless indicated otherwise, refers to the dried leady oxide paste from which the negative active materials is formed. During formation of the NAM, PbO in the leady oxide of the NAM oxide is converted to Pb.

The term “positive active material oxide” (or “PAM oxide”) as used herein, unless indicated otherwise, refers to refers to the dried leady oxide paste from which the positive active materials is formed. During formation of the PAM, PbO in the leady oxide of the NAM oxide is converted to PbO₂.

The term “dry unformed state” (or “DUF”) as used herein, unless indicated otherwise, refers to a state of the mass of pasted material in an electrode after drying and optionally also any curing, to a moisture content about 1% or less.

The term “fully charged” as used herein (and similar terms such as “state of full charge”, etc) refers to the state of a battery or cell or an electrode of a battery or cell at 100% state of charge (SoC). A battery or cell or an electrode of a battery or cell may be in a fully charged state following a charge with a minimum duration of 24 hours at 2.667V/cell for a flooded battery or 2.467V/cell for an AGM battery.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

Although the present invention is broadly as defined above, those persons skilled in the art will appreciate that the invention is not limited thereto and that the invention also includes embodiments of which the following description gives examples.

### BRIEF DESCRIPTION OF THE FIGURES

The invention is further described with reference to the accompanying figures by way of example wherein:

FIG. 1 is a plot of the cumulative intrusion volume in mL/g as a ratio (fraction) of the maximum intrusion volume vs pore size diameter in μm for negative electrodes of the invention formed from pastes having leady oxide (LO) contents of 77, 80, 83, and 86% from batteries B6129, B6135, B6141, and B6123, respectively, and traditional negative electrodes from batteries B6191, B6193, B6195, and B6197, respectively, as set out in Example 2. The plot shows that the electrodes of the present invention have a greater proportion of pores with a pore size diameter of from 10 to 90 μm and from 20 to 90 μm than the traditional electrodes,

FIG. 2 is a plot of the cumulative intrusion volume in mL/g vs pore size diameter in μm for negative electrodes of the invention formed from pastes having leady oxide (LO) contents of 77, 80, 83, and 86% from batteries B6129, B6135, B6141, and B6123, respectively, and traditional negative electrodes from batteries B6191, B6193, B6195, and B6197, respectively, as set out in Example 2. The plot shows that the electrodes of the present invention have volume of pores with a pore size diameter of from 10 to 90 μm and a volume of pores with a pore size diameter of from 20 to 90 μm greater than the volumes of pores in these pore size diameter ranges for the traditional electrodes. The plot also shows that electrodes of the present invention formed from pastes having a leady oxide content of 77%, 80%, and 83% have a greater maximum intrusion volume (total pore volume) than the traditional electrodes,

FIG. 3 is a plot of the flow in l/min vs pressure in bar of a dry (Dry Data) and wet (Wet Data) separator sample measured using the capillary flow porometry methodology as set out in Example 3,

FIG. 4 is a plot of cumulative pore flow in % vs pore size diameter in μm (Cumulative Flow %) and a plot of the differential flow in % vs pore size diameter in μm (Differential Flow %), showing the pore size diameter distribution of the separator obtained using the data shown in FIG. 3,

FIG. 5 the performance of a battery using electrodes of the present invention, and

FIG. 6 shows a schematic illustration of a confined pasting zone being implemented to impregnate a fabric material with paste.

### DETAILED DESCRIPTION OF PREFERRED EMBODIMENTS

The present invention broadly comprises a lead-acid battery or cell comprising a positive electrode, a negative electrode, and a separator disposed between the electrodes. The electrodes and the separator are porous, each having a pore size diameter distribution. The pore size diameter distribution of the electrodes is measured by mercury porosimetry. The pore size diameter distribution of the separator is measured by capillary flow porometry.

The term “pore size distribution measured by mercury porosimetry” and similar terms as used herein, such as “pore size distributions as measured by mercury porosimetry”, refer to a pore size distribution measured by mercury porosimetry in accordance with the ISO 15901-1:2016 standard. Samples of electrodes for the mercury porosimetry analysis are prepared in accordance with the method set forth in Example 2. In certain embodiments, the samples are prepared after carrying out electrical preconditioning of the battery as described in Example 2. The analysis should be carried out by an ISO accredited laboratory.

Unless indicated otherwise, pore size distributions as measured by mercury porosimetry referred to herein are of pores having a pore size diameter of 90 μm or less. Pores having a pore size diameter greater than 90 μm are not included in the mercury porosimetry analysis. For example, where a volume of pores of a pore size diameter greater than a stated value (such as 10, 15, 20, 30, or 35 μm), it will be appreciated that the volume is of pores having a pore size diameter greater than the stated value up to (but not exceeding) 90 μm. Similarly, where a total pore volume (or maximum intrusion volume) is indicated herein with respect to a pore size distribution measured by mercury porosimetry, it will be appreciated that the volume is of pores having a pore size diameter of 90 μm or less.

Unless indicated otherwise, pore size distributions as measured by capillary flow porometry referred to herein are of pores having a pore size diameter of 100 μm or less. Pores having a pore size diameter greater than 100 μm are not included in the capillary flow porometry analysis.

In some embodiments, the pore size diameter distribution of the positive and/or negative electrode comprises a ratio of a volume of pores having a pore size diameter greater than 20 μm to a total pore volume of at least 15%. In other embodiments, the pore size diameter distribution of the positive and/or negative electrode comprises a volume of pores having a pore size diameter greater than 20 μm of at least 0.020 ml/g. In some embodiments, the pore size diameter distribution of the positive and/or negative electrode comprises a ratio of a volume of pores having a pore size diameter greater than 10 μm to a total pore volume of at least 50%. In other embodiments, the pore size diameter distribution of the positive and/or negative electrode comprises a ratio of a volume of pores having a pore size diameter greater than a mode pore size diameter of the separator disposed between the electrodes to a total pore volume of at least 80%. In other embodiments, the pore size diameter distribution of the positive and/or negative electrode comprises: (a) a ratio of a volume of pores having a pore size diameter greater than 2 μm to a total pore volume of at least 85%; (b) a ratio of a volume of pores having a pore size diameter greater than 3 μm to a total pore volume of at least 80%; (c) a ratio of a volume of pores having a pore size diameter greater than 4 μm to a total pore volume of at least 75%; (d) a ratio of a volume of pores having a pore size diameter greater than 5 μm to a total pore volume of at least 75%; (e) a ratio of a volume of pores having a pore size diameter greater than 6 μm to a total pore volume of at least 70%; (f) a ratio of a volume of pores having a pore size diameter greater than 7 μm to a total pore volume of at least 70%; (g) a ratio of a volume of pores having a pore size diameter greater than 8 μm to a total pore volume of at least 65%; (h) a ratio of a volume of pores having a pore size diameter greater than 9 μm to a total pore volume of at least 55%; (i) a ratio of a volume of pores having a pore size diameter greater than 10 μm to a total pore volume of at least 50%; or (j) any combination of two or more of (a) to (i). In other embodiments, the pore size diameter distribution of the positive and/or negative electrode are as defined in any one of the other aspects above relating to batteries or cells of the invention. The volume of pores, total pore volume, and mode pore size diameter are as measured by mercury porosimetry for the electrodes and are as measured by capillary flow porometry for the separator (as part of measuring the pore size diameter distribution of the positive and negative electrodes and separator). In some preferred embodiments, at least the negative electrode has said ratio.

Advantageously, such an arrangement provides for optimal saturation of the separator material with an electrolyte, and may avoid or reduce dry-out of electrolyte from the separator, and/or may result in a dry out that preferentially occurs in the negative and/or positive electrode over the separator. In some embodiments, such preferential dry out occurs in the negative electrode. Alternatively or additionally, such an arrangement may result in a preferential dry out or reduction in electrolyte at the negative electrode and/or the positive electrode rather than in the separator as in traditional prior art battery constructions. In some embodiments, such preferential dry out or reduction in electrolyte occurs in the negative electrode. Without wishing to be bound, it is believed that in certain embodiments such an arrangement that provides for optimal saturation of the separator and/or preferential dry out or reduction in electrolyte in the positive and/or negative electrode rather than the separator, may result in an increase in the number of capacity turnovers compared to traditional prior art battery constructions.

The separator is disposed substantially between the positive and negative electrodes, acting to physically separate the electrodes and allow a flow of current, gas, and/or electrolyte to pass therethrough. Additionally, the separator must also be durable enough to withstand assembly operations and function reliably under the intense vibration and thermal stress it will encounter over the battery's service life. In certain embodiments, the separator may comprise, consist essentially of, or consist of an absorptive glass fibre mat material. Such separators are readily commercially available from Hollingsworth & Vose, for example. In some embodiments, the separator has a mode pore size diameter of less than or equal to about 20 μm, for example, less than 15, 10, or 5 μm, or a mode pore size diameter from about 1 to 20 μm, for example, from, about 1 to 15, 2 to 10, or 4 to 8, or 4 to 5 μm. For example, in some embodiments, the separator may have a mode pore size diameter of 5 μm or less, for example, from about 4 to 5 μm.

It has been found that at least in some embodiments batteries comprising a separator having a mode pore size diameter of about 5 μm or less and a positive and/or negative electrode having a pore size diameter distribution as defined in any of the aspects above relating to a battery or cell of the invention, such as a ratio of a volume of pores having a pore size diameter greater than 10 μm to a total pore volume of at least 50% or a ratio of a volume of pores having a pore size diameter greater than 20 μm to a total pore volume of at least 15%, have increased capacity turnovers compared to corresponding batteries constructed using traditional electrodes. It has also been found that the negative electrodes in such batteries of the invention have reduced electrolyte (measured as moisture) contents. Without wishing to be bound, it is believed this is consistent with dry out or reduction of electrolyte in the battery preferentially occurring in the negative electrode.

The battery or cell is assembled from positive and negative electrodes. The electrodes may be formed via a pasted process as described herein and with reference to PCT International Application PCT/IB2016/057459, published as WO 2017/098444 A1, which is incorporated herein by reference in its entirety such that a suitable pore volume and pore size diameter distribution is achieved. In some embodiments the electrodes may be provided with a lug. Alternatively, in other embodiments, the electrodes may not be provided with a lug, for example, where the electrodes are for use in VRLA's that do not require the same, such as bipolar batteries.

The paste in a preferred form comprises a mixture of Pb and PbO particles of Pb and PbO and dilute sulfuric acid. Alternatively, the paste may comprise lead sulphate (PbSO₄) particles and dilute sulphuric acid. The paste, for example for at least the negative electrode(s), may optionally also contain other additives such as carbon black, barium sulphate, and/or an expander such as a lignosulphonate. Examples of a suitable lignosulphonate include but are not limited to those available from Borregaard A.S. Norway and sold under the Vanisperse™ name such as Vanisperse™ A, or Vanisperse™ HT-1. Barium sulfate acts as a seed crystal for lead sulphate crystallisation, encouraging the lead to lead sulfate reaction. The expander may be provide in the paste or electrolyte, if soluble therein. The expander helps prevents agglomeration of sulphate particles at the negative plate, for example forming a solid mass of lead sulfate during discharge. For example, an expander may comprise between about 0.01% to 5%, 0.01% to 2.5%, 0.01% to 2%, 0.01% to 1.5%, 0.01% to 1%, 0.01% to 0.8% by weight of the active material-oxide. Conventionally, an expander at a concentration of around 0.2% by weight of the paste or more is added to the paste.

In various embodiments, the paste, for example at impregnation, has a density of at least 1.5 gm/cm³, for example at least 1.6, 1.7, 1.8, 1.9, 2, 2.1, 2.2, 2.3, 2.4, 2.5, 2.6, 2.7, 2.8, 2.9, or 3 gm/cm³ (and useful ranges may be selected from any two of these values). In some embodiments, the density is at least 3.5 gm/cm³, or at least 4.0 gm/cm³ or is between 1.5-7 gm/cm³, or is between 3 to 6.5 gm/cm³, or between 3 to 6 gm/cm³, or between 3 to 5.5 gm/cm³. In some embodiments, the paste, for example at impregnation, has a density of from between 1.5 to 7 g/cm³, more preferably between 2 to 6.5 g/cm³, more preferably between 2.5 to 6 g/cm³, more preferably between 3 to 5 g/cm³; or at least 1.5 gm/cm³, for example at least 1.6, 1.7, 1.8, 1.9, 2, 2.1, 2.2, 2.3, 2.4, 2.5, 2.6, 2.7, 2.8, 2.9, or 3 gm/cm³ (and useful ranges may be selected from any two of these values). In some embodiments, the density is at least 3.5 gm/cm³, or at least 4.0 gm/cm³ or is between 1.5 to 7 gm/cm³, or is between 3 to 6.5 gm/cm³, or between 3 to 6 gm/cm³, or between 3 to 5.5 gm/cm³, or between 3 to 5 gm/cm³.

In some embodiments, the NAM oxide has a density of at least 1.5 gm/cm³. In some embodiments, the NAM oxide has a density of at least 3 gm/cm³, or has a density of at least 3.5 gm/cm³.

In certain embodiments, the paste has a density of less than 5 g/cm³. In certain embodiments, the paste has a density from about 1.5 to 5 g/cm³. In certain embodiments, the paste has a density of from about 1.5 to 5.5 g/cm³.

The paste may have a sufficiently low shear strength to flow (slump) when placed in a cylindrical shape on a horizontal surface under gravity. A sufficient slump is seen for a noticeable slumping of a 30 mm high by 30 mm diameter cylinder, at impregnation into the electrode fabric. Preferably the paste has a creamy consistency. It has been found that this is achieved where the paste comprises less than about 6% weight by of sulphuric acid, or less than 5%, or less than 4%, or less than 3%, or less than 2% or less than 1%.

In some embodiments the paste has a yield stress in the range about 5 to about 500 Pa and/or a plastic viscosity in the range about 0.1 to about 5 Pa s.

In some embodiments the leady oxide content and/or the liquid component content of the paste can be varied to achieve the paste densities. In some such embodiments the leady oxide content is not greater than 88%, or not greater than 87%, or not greater than 86%, or not greater than 85%, or not greater than 84%.

In certain exemplary embodiments, the positive and/or negative electrode having said pore size distribution is formed from a paste having a leady oxide content not greater than 85% or not greater than 84%. In certain embodiments, the leady oxide content is not greater than 84%.

The electrodes may comprise an electrode framework. The electrode framework comprises a network suitable to provide structural form to the paste and/or to retain the same within the framework. In at least some embodiments the framework is provided with interconnected interstices and/or spaces. In at least some embodiments the electrode framework comprises a foam. In at least some embodiments the electrode framework comprises a fibrous material, such as a carbon fibre. In at least some further embodiments the fibrous material is a non-conductive fibrous material such as for example an oxidised polyacrylonitrile (PAN) fibre (OPF), glass fibre, silicon carbide fibre or alumina fibre material. The fibre material may be a woven material (comprising intersecting warp and weft fibres), a knitted material, or a non-woven material such as a fluid-entangled, for example hydro-entangled, material and/or a felt material or knitted carbon fibre material. Preferably the fibrous material has been hydro-entangled. Preferably the fibrous material has been needle punched. Preferably the bulk density of the fibrous material is about 0.05 g/cm³ to 0.2 g/cm³, or about 0.07 to 0.17 g/cm³ or about 0.08 to 0.15 g/cm³. The material typically has an average interfibre spacing between fibres in the fibre material of between about 1 and about 5 average fibre diameters and/or less than about 250 microns and in some embodiments less than about 200, less than about 100 microns, less than about 50 microns, less than about 20 microns, or less than about 10 microns. Alternatively, the material has an amount of cylindrical surface of fibres per unit volume of electrode 10³ to 10⁶ m²/m³. The fibre diameter may be in the range from about 1 micron to about 30 microns, from about 4 microns to about 20 micron, from about 5 microns to about 15 microns. In some embodiments, the average fibre diameter is less than about 20 microns. The voidage in the (unimpregnated) material may be at least about 80% or at least about 95% for example, to about 98% for example. Typically, the fibre material has length and width dimensions in a major plane of the material and an average thickness perpendicular to said major plane of the material, which may be for example about 0.2 mm or about 1 mm and/or less than 10 mm or less than 5 mm or less than 3 mm or less than 2 mm. Felt or other non-woven planar electrode material may be produced to very low thickness such as for example 2.5 mm. In at least some embodiments the fiber material comprises filaments of average length in the range 3 to 50 mm. The fiber material may have a thickness (transverse to a length and width or in plane dimensions of the electrode) many times such as about 10, 20, 50, or 100 times less than the or any in plane dimension of the electrode. The thickness may be less than about 10 mm, or less than about 5 mm or less than about 3 mm or less than about 2 mm or about or less than about 1 mm or about 0.2 mm for example. Each of the in plane length and width dimensions of the electrode may be greater than about 50 or about 100 mm for example. Such electrodes have a planar form with low thickness. In preferred forms the electrode is substantially planar and has a dimension from a metal lug, for example for VRLA battery applications, for external connection along at least one edge of the electrode less than about 200 mm, or less than about 150 mm, or less than about 100 mm or less than about 70 mm, or less than about 50 mm, or about 30 mm or less for example (with or without a macro-scale current collector). In various embodiments the width of the electrode is less than about 200 mm, or less than about 150 mm, or less than about 100 mm or less than about 70 mm, or less than about 50 mm, or about 30 mm. In various embodiments the width of the electrode is 140 mm. In larger embodiments electrodes may have length and/or width dimensions up to 1.5 m, up to 1 m, or between 0.5 to 1 m with or without a lug for example. Alternatively such a planar form may be formed into a cylindrical electrode for example. In some embodiments the fibre material may be conductive. For example the fibre material may be metallic fibre material or mesh, or a non-metallic fibre material which has been coated with a metallic material such as a Pb coating on the fibres for example. In other embodiments the fibre material may be non-conductive fibre material. The positive and/or negative electrode(s) may comprise, in addition to the positive active material (PAM) and/or negative active material (NAM), a lead or lead based material for collecting current and/or transferring current to and from the electrode, for example a metal lug, which may comprise a lead alloy, preferably a lead-calcium alloy, lead-tin alloy, or lead-aluminium alloy, or a combination of any two or more thereof. The PAM, NAM, and/or lead or lead based material preferably contain no or low levels of antimony as described herein.

The electrode framework, and if comprising a fibrous material, the fibres thereof may be flexible, which will assist in accommodating volume changes of the active material, (PAM/NAM) attached to the fibre material during battery cycling, and the microscale fibres may also reinforce the active material, to assist with and/or to maintain the pore sizing and/or pore volumes.

The electrode framework if comprising a fibrous current collector material may be supported mechanically and a supporting mechanical frame may also provide electrical connection of each electrode to the cell or battery terminals (external electrode connection). For example, one or more square or rectangular adjacent layers of the fibrous current collector material may be supported to form a planar battery plate by a peripheral metal frame on all sides or between opposite metal frame elements on two opposite sides. Alternatively, for example concentric cylindrical positive and negative plates may be supported at either cylindrical end by circular metal frames. Generally, all forms of external connector are referred to herein as a ‘lug’.

The porosity of the electrodes may be varied by for example using pastes of different densities. It has been found that at least in some embodiments using a paste having a lower paste density (or leady oxide content) can provide electrodes having a greater proportion of pores having a pore size diameter, for example, greater than 5 μm, more particularly greater than 10 μm, or more particularly greater than 20 μm (such as, greater than 25 μm, 30 μm, or 35 μm). As described in the Examples, the use of a paste having a leady oxide content of 77% leads an electrode having greater proportions of pores having pore size diameters greater than 5 μm, 10 μm, or 20 μm than an electrode prepared from a paste having an 86% leady oxide content. Paste density is an important factor in the structural strength of the active material of an electrode. The particle-to-particle connections in the active material need to be strong enough to withstand the charge/discharge process without the particles losing contact and to withstand applied forces such as vibrations, bumps, etc. in use. While the porosity of an electrode may be increased by reducing paste density (e.g. increasing the amount of water in the paste relative to the amount of lead oxide), the structural strength of the active material formed may be reduced. Without wishing to be bound, it is believed that at least in some embodiments the use of an electrode framework comprising a fibrous material may provide structural strength to electrodes prepared from lower density pastes.

After mixing, the paste is applied to the electrode framework, by applying the paste to the electrode framework or vice versa, typically under pressure. In some of such embodiments pasting occurs using a pasting machine. In at least some embodiments the process comprises applying the paste to the electrode framework by impregnating the paste into the electrode framework under pressure. The pressure is sufficient to overcome flow resistance of the fibres to the paste, frictional flow resistance of the fibres to the paste and paste surface tension forces. In some embodiments the pressure applied to the paste is within the pressure range of 0.2 kPa to 100 kPa, from between 0.2 to 80 kPa, or from between 0.2 Kpa to 60 kPa. In some embodiments the paste is subjected to an ultrasound vibration of a frequency in the range of 5 Hz to 500 KHz.

In further embodiments the pressure is provided in a confined pasting zone as part of a paste application zone. The confined pasting zone comprises moving a fibre material through the confined pasting zone, a vibrator to vibrate the paste in the confined volume, and a pressure supply arranged to maintain pressure on the vibrating paste, to impregnate the paste through a major surface of the fibre material and into and through the fibre material. This confined pasting zone can be provided as part of a machine for impregnating a paste into a fibre material, where the carbon fibre material is continuously moved through the machine, in further embodiments the carbon fibre material can be under tension. In further embodiments the machine may be arranged to compress the fibre material as it moves into and/or through the confined pasting zone. This same confined pasting zone can further be provided without the use of a machine.

In some embodiments any variation in the mass loading of lead (or Pb equivalent) per cm³ of internal volume of the fibre material is less than 50% or less than 30% or less than 20%. In other embodiments greater than about 50% or greater than about 65% or greater than about 80% of (the total volume of) paste impregnated into and on a surface or surfaces of the fibre material is in the internal volume of the fibre material.

With reference to FIG. 6. This illustrates schematically the impregnation of the paste into the fibre material 4 whilst moving in a machine direction indicated by arrow MD. The fibre is being drawn by driven rollers 12. The fibre material 4 moves over a flat surface 1 such as a flat pate. The paste P is delivered onto the fibre material 4 opposite the surface 1, from a paste supply (not shown) through a paste delivery outlet 5 comprising in particular an orifice 6 which is at least wide across the machine direction as the width of the fibre material 4. Immediately forward of the paste delivery outlet 5 in the machine direction is a vibrator 3, having a lower surface 8. The lower surface 8 extends across the fibre material 4 and angles downwardly towards the fibre material in the machine direction as shown, although it is envisaged the lower surface 8 can be moved within a range of movement from the angled position to a substantially co-planar position with the fibre. A confined pasting zone is defined forward of the orifice 6, between the underside 8 of the vibrator 3 and the surface 1. In some instances the cross-section area (approximately triangular in cross-section in FIG. 6) of the confined pasting zone, in the machine direction, reduces in the machine direction as shown. However, in alternative embodiments, the confined pasting zone has a height perpendicular to the plane of the surface 1 and fibre material 4 that are co-planar.

In use, as the fibre material 4 moves forward in the machine direction, paste moving under pressure as indicated by arrow P is continuously delivered under pressure from orifice 6 into the confined pasting zone defined between the lower face 8 of the vibrator 3 and the surface 1 beneath it, and left and right side walls on either side of the confined pasting zone. The paste is delivered under a pressure for example, pumping pressure, which maintains a static pressure on the wedge-shaped body of paste 2 maintained within this confined pasting zone, which assists in impregnating paste into the fibre material.

The paste in the confined pasting zone may be considered as a body of flowing paste under pressure and may also be fluidised by vibration, the pressure being a static pressure sufficient to overcome the flow resistance of the fibres, so that the pate flows into and continuously impregnates the paste through the major surface of the fibre material.

In some embodiments, the porosity of an electrode comprising a fibrous material as an electrode framework may be varied by controlling the method by which the fibrous material is impregnated with paste. For example, the degree of penetration of the paste into the fibre material and the resulting porosity of an electrode formed therefrom may be controlled by varying the pressure applied to the paste and/or vibration during impregnation.

After pasting, the electrodes are dried, for example by air drying or flash drying, and then cured. Air drying may be at a temperature of less than 40° C. or less than 30° C., for a time of at least 4 hours or at least 12 hours or at least 18 hours or at least 24 hours, for example. In some embodiments drying is by flash drying. Flash drying may not expose the electrodes to a temperature greater than 80° C. for more than 60 seconds, or for not more than 40 seconds, or for not more than 30 seconds. In some embodiments, flash drying comprises exposing the electrodes to an elevated temperature, preferably not more 80C, for a short period of time, for example not more than 60, 40, 30, or 20 seconds. In at least some embodiments, the dried electrodes are dry to the touch and/or sufficiently dry to be capable of being stacked on top of one another without sticking together. The flash dried electrodes may have a moisture content (being a mass percentage of the flash dried paste that is water) of less than about 15%, 14%, 13%, or 12%, for example from about 2 to 14, 3 to 14, 5 to 14, 2 to 13, 3 to 13, 5 to 13, 2 to 12, 3 to 12, 5 to 12, or 7 to 12%. In some embodiments, flash drying may reduce the moisture content of the electrodes to about 9%.

The dried electrodes are then transferred to an oven and subjected to curing. In various embodiments, curing reduces the moisture content (being a mass percentage of the flash dried paste that is water) of the electrodes to less than about 1%, for example less than about 0.9, 0.8, 0.7, 0.6, 0.5, 0.4, 0.3, or 0.2%. In some embodiments stacks of 5 or more electrodes are provided to the oven at one time. In the curing process after the electrodes are transferred to the oven, the temperature of the oven is slowly increased from room temperature to a temperature of at least about 50C, for example 60C, while maintaining a high relative humidity, for example at least 90C. The oven is then maintained at this elevated temperature as the relative humidity is slowly reduced to a relative humidity of about less than 20%, for example 10%. This low relative humidity and elevated temperature is then maintained for a period of time, before progressively reducing said temperature to room temperature while increasing the relative humidity to about, for example 20%.

The electrodes are then inserted into a cell container, and electrically connected, as alternating positive and negative electrodes with a suitable separator between each positive and negative electrode. Electrolyte is then added to the cell. The rate of electrolyte addition may be controlled so that the cell temperature does not rise above about 60° C. or about 70° C. or about 80° C. (due to exothermic reaction). Controlling said temperature may prevent or minimise the expander, for example lignosulfonate, from being destroyed/denatured. The electrolyte may be chilled, for example to less than 20° C., or less than 10° C. or less than 5° C., or to about 0° C. or less, or to about-10° C. or less. Prior to adding the electrolyte alternatively or additionally the cell or battery may be chilled, for example in a cooled water bath, for example to less than 20° C., or less than 10° C., or less than 5° C., or to about 0° C. or less, or to about −10° C. or less.

After assembly, the battery or cell is then subjected to an initial charge for cell formation. During initial electrode or cell formation (first charge cycle during which active particle linkages form) after cell or battery construction, electrode or cell formation occurs first by building a conducting framework, taking up most of the Pb in the negative active material, building normally over lengths of several millimetres (connecting strings of perhaps a thousand or more micron sized particles end to end). This stage also produces small PbSO₄ particles. Second, these smaller particles attach to this conductive framework to provide and receive current. It may be advantageous that during formation the charging current is pulsed periodically.

12V VRLA AGM batteries generally follow a standard construction process where a 2V cell or plate group is constructed using the electrodes in an alternative configuration of 1 negative, 1 positive with a separator in between. The plate groups are then stacked together, to form a stack which can then undergo compression to ensure each stack fits into the chambers of the battery casing and to ensure contact between the electrodes themselves and the separator. In some cases, a plunger moves across the top of the plate group to force the battery stack into each of the chambers. Each chamber with a stack or plate group is now a cell. A cast on strap is applied to connect each cell to the terminals of the batteries. A lid is placed securely on the battery casing. Electrolyte filling then commences, where a vacuum is drawn on the battery and at the same time the electrolyte is introduced into the battery. The vacuum forces electrolyte into the separator and plates. This process may be repeated several times to ensure full saturation. The battery is then ready to undergo formation. This general process can be used for any alternative sized batteries, for example 48V.

Bipolar batteries differ from monopolar batteries, such as monopolar AGM batteries, in that bipolar plates replace the chamber walls and the electrodes and/or the NAM/PAM are not provided with lugs. The bipolar plates are permeable to electron flow through the faces of the bipolar walls but are impermeable to electrolyte. In all other respects the bipolar battery can be constructed using a similar construction technique to that used for a monopolar AGM battery. A cathode or negative electrode comprising NAM and an anode or positive electrode comprising PAM are provided on opposing surfaces of an electrically conductive substrate so as to provide the bipolar plate or bipolar electrode. The bipolar battery may comprise one bipolar plate, but typically comprises a stack of bipolar plates. The battery comprises a positive end comprising a positive electrode and negative end comprising a negative electrode located at opposite ends of the bipolar plate or stack of bipolar plates, facing electrodes of opposite polarity with separators in between. In embodiments where the battery comprises a stack of bipolar plates, the stacks are stacked with separators in between such that electrodes of opposite polarity face each other. The stacks are then assembled and provided and/or inserted into a battery casing. The stacks are compressed to ensure the electrodes and separators are compressed against one another. A lid is placed on the casing or the casing otherwise sealed and a vacuum is drawn as in the AGM construction described whereupon electrolyte is added. Again, this process of electrolyte addition can be carried out several times to ensure full saturation of the separator. The battery is then ready to undergo formation.

In various embodiments, batteries of the invention meet one or more of the requirements for water consumption according to the European Standard (EN5042-1:2015), as set out below:

| | | | Weight loss |
|---|---|---|---|
| Requirement level | Test temperature | Duration (days) | g/(Ah C₂₀) |
| W1 | +60° C. ± 2° C. | 21 | <24 |
| W2 | +60° C. ± 2° C. | 21 | <16 |
| W3 | +60° C. ± 2° C. | 42 | <8 |
| W4 | +60° C. ± 2° C. | 42 | <4 |
| W5 | +60° C. ± 2° C. | 84 | <4 |

In some embodiments the water consumption of the battery is less than 9 g/(Ah C₂₀), or less than 8 g/(Ah C₂₀), or less than 7 g/(Ah C₂₀), or less than 6 g/(Ah C₂₀), or less than 5 g/(Ah C₂₀) or less than 4 g/(Ah C₂₀), or less than 3 g/(Ah C₂₀) or less than 2 g/(Ah C₂₀).

### EXAMPLES

The following non-limiting Examples are provided to illustrate the present invention and in no way limit the scope thereof.

### Example 1—Preparation of Electrodes and Construction of a Battery

This Example sets out the preparation of electrodes of the invention and construction of batteries using the same.

### Method

### Electrode Preparation

Electrodes of the invention were prepared by the following method. Into a mixing bowl fitted with a mixer, a leady oxide paste containing the quantity of leady oxide as set out in Table 1 below was mixed with an amount of an expander, dissolved in deionised water. The remaining ingredients were then added to the bowl. Mixing was commenced again for a total mixing time of no more than 15 minutes. This resulted in a paste slurry, which was then used to paste a carbon fibre felt fabric provided with lead lugs. The carbon fibre felt (available from Zoltek Corporation as a hydroentangled fibre) has an areal density of between 120-160 gm/m² with a carbon volume fraction of approx. 5%. The pasted electrodes were then flash dried to achieve a moisture content of between 3-20% and then cured in a humidity and temperature-controlled curing oven. The cured plates were then used to construct a battery of the invention.

TABLE 1
Quantities of materials
Ingredients

| | | Barium | | | |
|---|---|---|---|---|---|
| Leady oxide | Leady oxide | sulfate | H₂SO₄ | Water | Expander |
| (%) | (g) | (g) | (g) | (g) | (g) |
| 77% | 33,980 | 271.9 | 328.9 | 9,490.8 | 27.2 |
| 80% | 22,610 | 180.9 | 181.5 | 5,249.4 | 18.1 |
| 83% | 22,710 | 181.7 | 90.4 | 4,338.5 | 18.2 |
| 86% | 34,510 | 276.0 | 17.2 | 5,262.4 | 27.6 |

### Battery Construction

Batteries of the invention B6129, B6135, B6141, and B6123 were constructed by assembling one negative, two positive (1N/2P) cells using negative electrodes of the invention prepared using the 77%, 80%, 83%, and 86% leady oxide pastes, respectively, in the dry unformed state and traditional positive electrodes with a Daramic DuraLife® (a polyethylene battery separator) separator in between.

Control batteries B6191, B6193, B6195, and B6197 were constructed by assembling one negative, two positive (1N/2P) cells using traditional positive and negative electrodes in the dry unformed state with a Daramic DuraLife® (a polyethylene battery separator) separator in between. B6191 and B6197 contained traditional negative electrodes for an enhanced flooded battery (EFB) from different manufacturers. B6193 and B6195 contained traditional negative electrodes for an AGM battery from different manufacturers.

### Battery Formation

From construction, the cells of the control batteries and batteries of the invention were first soaked in 1.15 sg sulfuric acid electrolyte for one hour. The cells were then connected to an Arbin BT2000 test bench, with the nominal positive electrode connected to the positive electrode terminal and the nominal negative electrode terminal connected to the test bench's negative lead. The cells were then formed by charging to convert the electrodes to their respective polarities, where the leady oxide on the positive was converted to PbO₂ and the leady oxide on the negative was converted to Pb. The cell was fully charged.

### Example 2—Mercury Porosimetry Testing

This Example sets out the preparation and testing of samples for porosity by mercury intrusion porosimetry.

### Method

The cells from Example 1 after formation were then placed on the following electrical preconditioning test.

### Electrical Preconditioning

After formation, each battery was subjected to a C₂₀ discharge (full discharge to 1.75 V/cell at the 20-hour discharge rate) and subsequently fully charged for 24 hours, with a current limit of 5 times the 20 hour rate and a voltage limit of 2.667 V/cell.

### Dismantling and Preparation of Electrodes for Sampling

To ensure batteries were fully changed prior to dismantling, each battery was charged for 16 hours, with a current limit of 5 times the 20 hour rate, and a voltage limit of 2.667 V/cell. The batteries were dismantled within two hours of charge completion, and the negative electrode extracted from the battery.

The negative electrode was washed with isopropanol immediately upon extraction from the dismantled battery. The electrode was immediately fully emersed in isopropanol, with the electrode orientated vertically. The volume of isopropanol was at least about 10 times the geometric volume of the emersed electrode. A lid was applied to the container to prevent atmospheric oxygen ingress. After soaking for two hours, the isopropanol was exchanged by pouring out the free isopropanol and adding an equal volume of fresh isopropanol. After soaking for two hours, a second isopropanol exchange was performed and the electrode then allowed to soak for 16 hours. A third and final isopropanol exchange was then performed. After soaking for two hours, the free isopropanol was poured out and the electrode placed vertically in a vacuum oven.

The electrodes were dried at 40° C. under vacuum (less than 10% atmosphere) for at least 4 hours until fully dry (typically to provide a moisture content of less than 0.5%). Throughout the dismantling, washing and drying processes, care was taken to strictly limit exposure of the electrode to air, and thus minimise oxidation of lead (due to oxygen in the atmosphere). Additionally, at no point during the dismantling, washing, drying and sampling processes were the electrode samples exposed to water or high humidity—as exposure to water during washing and drying is known to result in oxidation and recrystallization artifacts in lead electrodes.

### Sampling of Electrodes for Mercury Intrusion Porosity Measurement

Electrodes were subdivided into smaller samples and sealed into vacuum pack bags to exclude oxygen during transport of the samples to an International Organisation for Standardisation (ISO) accredited external laboratory for mercury intrusion porosimetry testing.

The method by which the samples were subdivided depended on the underlying electrode framework or grid of the electrode. Electrodes of the invention utilising a carbon fibre felt fabric as an electrode framework were cut from the electrode's (horizontal) centre into samples measuring approximately 100 mm×50 mm. Traditional electrodes utilising a conventional lead frame grid as the electrode framework were sampled by carefully pushing the pellets of active material out of the centre section of the lead frame. The active material pellets measured approximately 4.0 mm by 4.0 mm by 1.6 mm.

The samples were then packaged in vacuum sealed bags ready for mercury intrusion porosity testing. The samples were then sent to the ISO accredited external laboratory. Sub-sampling of the provided samples was performed by the ISO accredited external laboratory in accordance with its procedures. The samples were then subjected to mercury porosimetry analysis in accordance with the ISO 15901-1:2016 standard.

No sample conditioning was performed by the external laboratory prior to porosimetry measurement (conditioning which results in significant exposure to air or moisture, or exposure to temperatures above 40° C. should be avoided)—the samples were tested as provided. Traditional electrode sample pellets were taken directly from their vacuum packaging and placed in the penetrometer. Samples of the invention were provided to the external laboratory in excess dimension, so a single, appropriately dimensioned piece was cut using a scalpel blade and placed into the penetrometer.

A MicroActive AutoPore V 9600 Version 2.03.22 instrument was used. Samples of the traditional art were measured in a 5 Bulb, 1.131 Stem, Powder penetrometer. Samples of the invention were measured in a 5 Bulb, 0.392 Stem, Solid penetrometer. A ‘blank’ correction was run on each penetrometer prior to sample measurement. Samples were measured with the low-pressure evacuation target pressure set to 30 μmHg, achieved via an initial evacuation rate of 3.0 psia/min, and upon reaching target pressure, evacuation continued for 5 min. A mercury filling pressure of 1.0 psi was used. An equilibration rate for both low and high pressure operations of 0.050 μL/g's was used. The mercury contact angle was set to 140 degrees and the mercury surface tension to 485.0 dynes/cm.

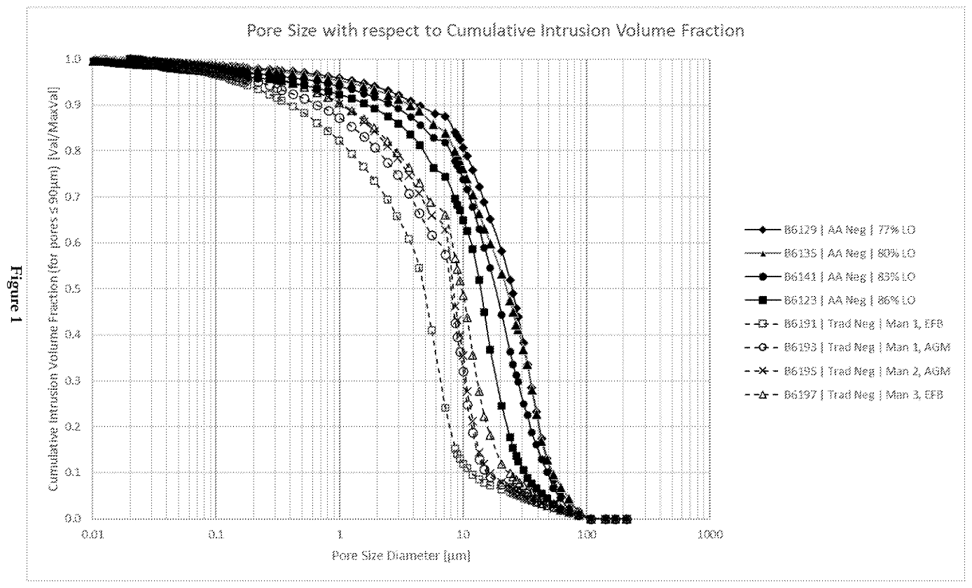

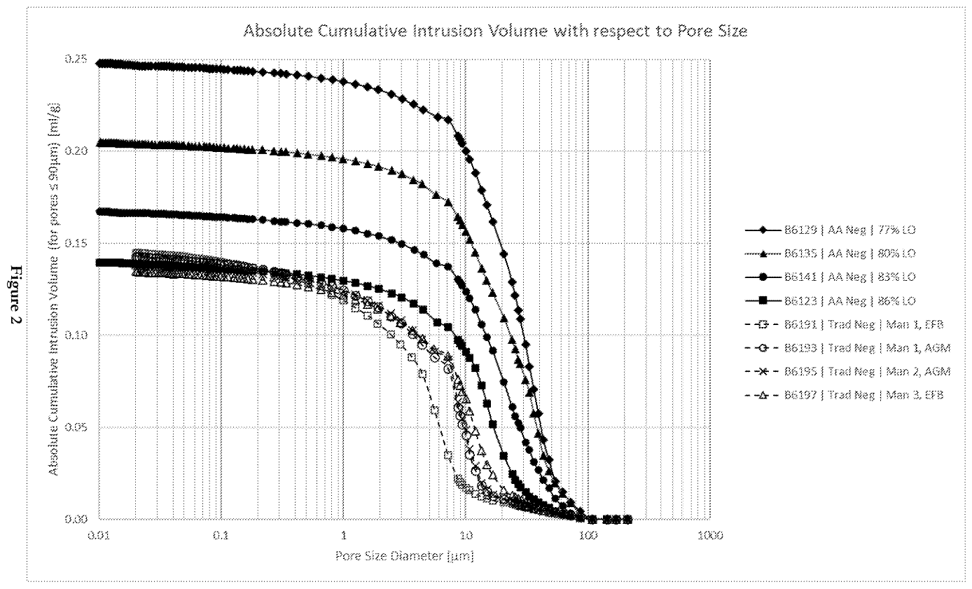

The results of the analysis are set out in Tables 2 and 3 below and in FIGS. 1 and 2. This pore volume and pore size diameter distribution analysis excludes pores having a diameter of greater than 0 μm.

TABLE 2
Pore Size with respect to Cumulative Intrusion Volume Fraction

| | | Battery ID | | | | | | | |
|---|---|---|---|---|---|---|---|---|---|
| | | B6129 | B6135 | B6141 | B6123 | B6191 | B6193 | B6195 | B6197 |
| | | Electrode | | | | | | | |
| | | 77% PbO | 80% PbO | 83% PbO | 86% PbO | Traditional | Traditional | Traditional | Traditional |
| Cumulative | | negative | negative | negative | negative | negative | negative | negative | negative |
| Intrusion | | Pore Diameter | | | | | | | |
| Volume | | (x % of component's measured Hg Intrusion volume ≤90 μm which | | | | | | | |
| Fraction | | occurs at pore diameters greater than or equal to that diameter indicated) | | | | | | | |
| [%] | [fraction] | [μm] | [μm] | [μm] | [μm] | [μm] | [μm] | [μm] | [μm] |
| 5 | 0.05 | 66.2 | 69.6 | 59.8 | 45.3 | 27.7 | 31.4 | 31.3 | 40.4 |
| 10 | 0.10 | 52.0 | 53.3 | 48.3 | 31.6 | 11.6 | 15.6 | 16.4 | 23.6 |
| 15 | 0.15 | 45.8 | 45.4 | 40.6 | 25.7 | 8.7 | 12.9 | 13.3 | 18.6 |
| 20 | 0.20 | 41.4 | 41.1 | 35.0 | 22.8 | 7.9 | 11.7 | 12.3 | 15.8 |
| 25 | 0.25 | 38.2 | 37.9 | 30.9 | 20.4 | 7.1 | 10.8 | 11.3 | 14.2 |
| 30 | 0.30 | 35.2 | 35.0 | 27.7 | 18.8 | 6.6 | 10.3 | 10.6 | 13.1 |
| 35 | 0.35 | 32.5 | 32.2 | 24.6 | 17.2 | 6.1 | 9.6 | 10.1 | 12.1 |
| 40 | 0.40 | 29.9 | 28.7 | 22.4 | 15.9 | 5.6 | 8.9 | 9.4 | 11.3 |
| 45 | 0.45 | 27.3 | 25.4 | 20.3 | 14.9 | 5.2 | 8.4 | 8.8 | 10.6 |
| 50 | 0.50 | 24.9 | 22.5 | 18.4 | 13.9 | 4.8 | 7.9 | 8.3 | 9.8 |
| 55 | 0.55 | 22.3 | 19.5 | 16.4 | 12.8 | 4.4 | 7.4 | 7.9 | 8.9 |
| 60 | 0.60 | 19.5 | 16.6 | 14.5 | 11.6 | 3.7 | 6.2 | 7.4 | 8.1 |
| 65 | 0.65 | 16.7 | 14.1 | 12.9 | 10.0 | 3.0 | 4.8 | 6.1 | 7.3 |
| 70 | 0.70 | 14.4 | 12.2 | 11.3 | 8.5 | 2.4 | 3.8 | 4.6 | 5.2 |
| 75 | 0.75 | 12.3 | 10.4 | 9.6 | 6.7 | 1.7 | 2.9 | 3.6 | 4.0 |
| 80 | 0.80 | 10.3 | 8.6 | 7.8 | 4.8 | 1.2 | 2.0 | 2.6 | 2.9 |
| 85 | 0.85 | 8.2 | 6.3 | 4.8 | 3.3 | 0.7 | 1.3 | 1.8 | 1.9 |
| 90 | 0.90 | 4.3 | 3.7 | 2.6 | 1.7 | 0.4 | 0.7 | 1.0 | 1.1 |
| 95 | 0.95 | 1.4 | 1.1 | 0.7 | 0.4 | 0.2 | 0.2 | 0.4 | 0.4 |

TABLE 3
Absolute Cumulative Intrusion Volume with respect to Pore Size
In this table, the “ml/g” value of any given row is the intruded
volume between 90 μm and pore diameter stated for that row {x}.
Values are inclusive (i.e. include the bounding values of “x” and 90 μm).

| | Battery ID | | | | | | | |
|---|---|---|---|---|---|---|---|---|
| | B6129 | B6135 | B6141 | B6123 | B6191 | B6193 | B6195 | B6197 |
| | Electrode | | | | | | | |
| | 77% PbO | 80% PbO | 83% PbO | 86% PbO | Traditional | Traditional | Traditional | Traditional |
| | negative | negative | negative | negative | Negative | Negative | Negative | Negative |
| Pore | Absolute Cumulative Intrusion Volume | | | | | | | |
| Diameter | (cumulative Hg Intrusion volume for all measured | | | | | | | |
| {x} | pore diameters between “x” and 90 μm inclusive) | | | | | | | |
| [um] | [ml/g] | [ml/g] | [ml/g] | [ml/g] | [ml/g] | [ml/g] | [ml/g] | [ml/g] |
| 0.02 | 0.247 | 0.204 | 0.166 | 0.139 | 0.145 | 0.143 | 0.138 | 0.135 |
| 0.1 | 0.245 | 0.202 | 0.164 | 0.136 | 0.140 | 0.139 | 0.135 | 0.132 |
| 1 | 0.238 | 0.196 | 0.158 | 0.130 | 0.119 | 0.124 | 0.124 | 0.122 |
| 2 | 0.233 | 0.191 | 0.154 | 0.125 | 0.105 | 0.115 | 0.115 | 0.114 |
| 4 | 0.224 | 0.184 | 0.146 | 0.116 | 0.084 | 0.098 | 0.100 | 0.101 |
| 6 | 0.218 | 0.176 | 0.139 | 0.107 | 0.053 | 0.086 | 0.090 | 0.091 |
| 8 | 0.212 | 0.168 | 0.133 | 0.101 | 0.028 | 0.070 | 0.074 | 0.082 |
| 10 | 0.200 | 0.157 | 0.124 | 0.091 | 0.017 | 0.046 | 0.049 | 0.066 |
| 12 | 0.188 | 0.145 | 0.114 | 0.082 | 0.014 | 0.027 | 0.029 | 0.048 |
| 15 | 0.170 | 0.129 | 0.099 | 0.062 | 0.011 | 0.015 | 0.016 | 0.029 |
| 20 | 0.147 | 0.111 | 0.077 | 0.037 | 0.009 | 0.011 | 0.011 | 0.017 |
| 25 | 0.124 | 0.094 | 0.058 | 0.022 | 0.008 | 0.009 | 0.009 | 0.013 |
| 30 | 0.099 | 0.078 | 0.044 | 0.016 | 0.007 | 0.008 | 0.007 | 0.010 |
| 35 | 0.075 | 0.062 | 0.034 | 0.011 | 0.006 | 0.006 | 0.006 | 0.008 |
| 40 | 0.055 | 0.045 | 0.026 | 0.009 | 0.005 | 0.005 | 0.005 | 0.007 |
| 45 | 0.039 | 0.031 | 0.020 | 0.007 | 0.004 | 0.005 | 0.004 | 0.006 |
| 50 | 0.028 | 0.024 | 0.015 | 0.006 | 0.004 | 0.004 | 0.004 | 0.005 |
| 55 | 0.020 | 0.019 | 0.011 | 0.004 | 0.003 | 0.004 | 0.003 | 0.004 |
| 60 | 0.016 | 0.015 | 0.008 | 0.003 | 0.003 | 0.003 | 0.003 | 0.004 |
| 70 | 0.010 | 0.010 | 0.004 | 0.002 | 0.002 | 0.002 | 0.002 | 0.003 |

In a typical mercury porosimetry analysis, a sample is placed into a vacuum sealed sample cup containing a quantity of mercury and pressure is then applied. In general, it is the resistance of the surface tension of the mercury acting along the line of contact with the pores that creates a force resisting entry of the mercury that is measured to ascertain the porosity of the sample. By measuring the volume of mercury that intrudes into the sample as the pressure is increased, the volume of pores in the sample of a corresponding pore size diameter can be determined. The pore size diameter distribution is calculated using the Washburn equation. A plot of the cumulative intrusion volume vs pore size diameter is obtained, enabling the volume of pores having a particular pore size diameter and the total volume of the pores of the sample to be determined. A plot of the log differential intrusion vs pore size diameter is also obtained, enabling the mode pore size diameter of the sample to be determined. The mode pore size diameter denotes the pore size diameter at the peak of greatest intruded volume (i.e. the highest peak) in the log differential plot.

### Results

Table 2 shows that the fraction or ratio (as a %) of the volume of pore size diameters greater than 10 μm to the total pore volume (maximum intrusion volume) is between about 80 to 85% for the 77% PbO pasted electrode and between about 60 to 65% for the 86% PbO pasted electrode, but less than 50% for each of the traditional electrodes. Similarly, the fraction or ratio (as a %) of the volume of pore size diameters greater than 20 μm to the total pore volume is between about 25 to 30% for the 77% PbO pasted electrode and between about 55 to 60% for the 86% PbO pasted electrode, but less than 15% for each of the traditional electrodes. This is also shown in FIG. 1, which plots data included in Table 2.

Table 3 shows that the cumulative intrusion volume at a pore size diameter of 10 μm or 20 μm for all of the electrodes of the invention is greater than the traditional electrodes. Table 3 shows that electrodes of the invention have a volume of pores having a pore size diameter greater than 20 μm (to 90 μm) of at least 0.020 ml/g. This is also illustrated in FIG. 2, which plots data included in Table 3. FIG. 2 also shows that the 77%, 80%, and 83% PbO pasted electrodes have a greater maximum intrusion volume than the traditional electrodes.

### Example 3—Capillary Flow Porometry

This Example sets out the preparation of samples for capillary flow porometry (also known as liquid expulsion porometry or gas-liquid displacement porometry).

### Method

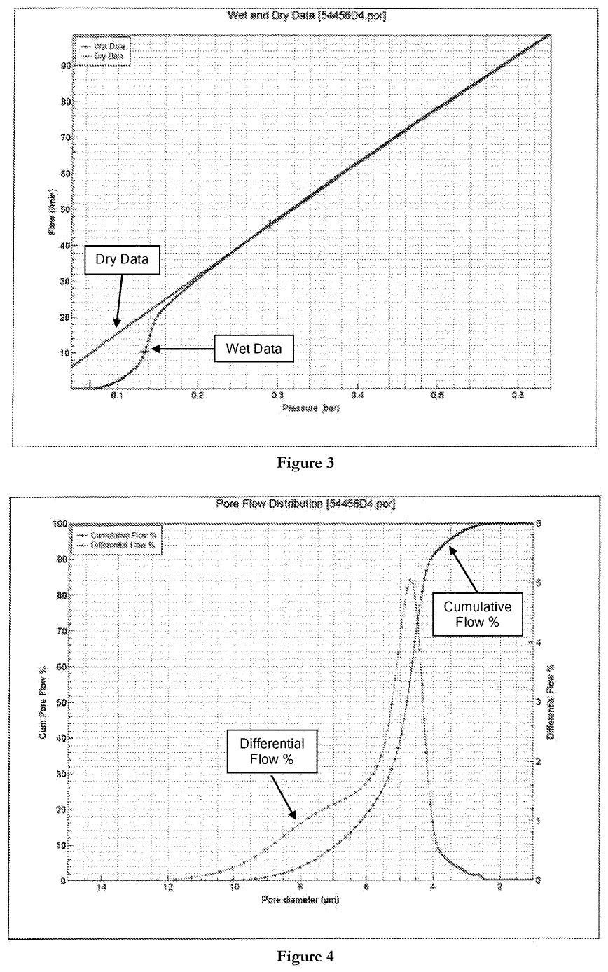

A circular disk of 25 mm diameter sample of the same type of separator used in the batteries of the invention from Example 1 were cut. The sample was then subjected to capillary flow porometry. The results of the analysis are set out in FIGS. 3 and 4.

In a typical analysis, as carried out in the art, the sample is wetted with Porofil, a liquid of known viscosity and surface tension, to fill at least all through pores. The wetted sample is then sealed into a sample holder. Gas pressure (air or nitrogen) is then applied to one side of the sample. In general, the liquid is emptied from the largest to smallest pores as the gas pressure increases. The resulting flow of gas is measured until all pores are emptied of the liquid. This analysis is then repeated on the sample without wetting (i.e. on the sample in a dry state). This results in wet and dry curves for the sample, plotting the flow of gas vs pressure. The wet and dry curves obtained for the glass fibre matt sample SP020 is shown in FIG. 3. From these wet and dry curves, the pore size diameter distribution can be calculated using the Washburn equation. The pore size diameter distribution of the glass fibre matt sample SP020, obtained using the data shown in FIG. 3, is illustrated in FIG. 4. The Differential Flow % plot in FIG. 4 shows the mode pore size diameter of the separator.

### Example 4—Cycle Life

This Example shows improved cycle life of a VRLA battery, in particular a bipolar battery, utilising an electrode of the present invention.

### Method

A bipolar battery was constructed by assembling a 77% leady oxide content negative electrode made in accordance with Example 1, a traditional positive electrode, an electrically conductive substrate for a bipolar plate, and AGM separators and then providing to a battery casing. The battery then underwent the battery formation procedure set out in Example 1. In its fully charged state, the battery was then transferred for deep discharge cycling according to the following procedure.

### Deep Discharge Cycling

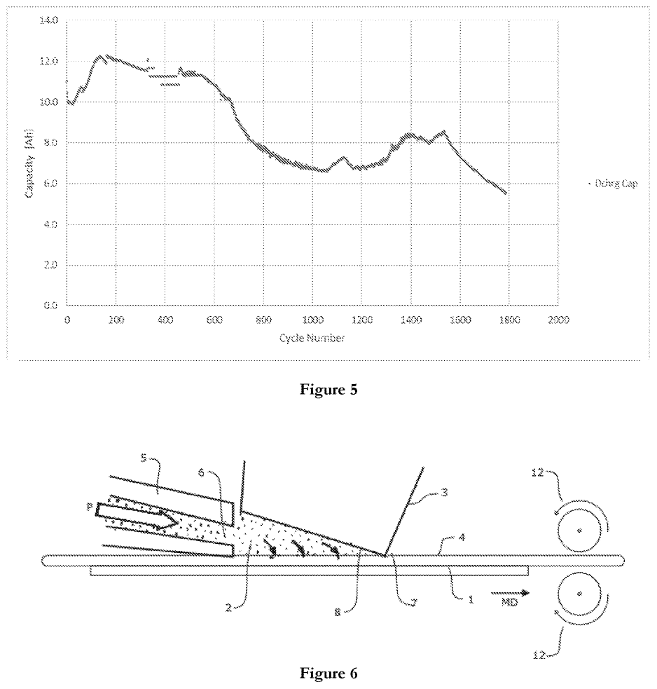

The test procedure comprised a long-term testing regime in accordance with Battery Council International Standard BCIS-06, where the battery was subjected to full 100% deep discharge and recharge cycles. Performance is measured by the number of deep discharge cycles (capacity turn overs) the battery can sustain before the battery drops below a certain level performance, such as 50% of its starting performance as measured in capacity (Ah). The results of the deep discharge cycling performance of the bipolar battery in this Example is set out in FIG. 5.

### Results

As shown in FIG. 5, the battery had a starting capacity of 10 Ah, rising to 12 Ah at around 200 cycles. The battery performance did not drop to below 50% of its starting capacity until around 1750 cycles. In comparison, a typical LAB would be expected to have a cycle life (life until performance drops to below 50% of starting capacity) of only around 500 cycles.

### Example 5—Moisture Content

This Example illustrates the negative electrode acting as an electrolyte reservoir.

### Method

A 2V 60 Ah battery (nominal capacity) was constructed using 86% leady oxide pasted electrodes as described in Example 1 as the negative electrodes in a 7 negative, 6 positive (7N/6P) configuration. The positive electrodes were commercially available traditional positive electrodes. The positive electrodes were paired up with negative electrodes with a glass fibre material AGM separator for automotive batteries (available from Hollingsworth & Vose) in between. A control flooded 7N/6P battery was also constructed using traditional negative and positive electrodes with an automotive battery separator as used in Example 1 in between the negative and positive electrodes.

The batteries then underwent the battery formation procedure set out in Example 1. The batteries were then transferred to a 16-hour post formation test to ensure the battery was fully charged.

On completion of the post formation test, the batteries were transferred for DCA testing using the Ford EU (Test B) DCA test protocol. Ford EU testing on the batteries was carried out for 13 weeks. Upon completion of DCA testing, the batteries then underwent a C20 capacity test—which is an industry standard test for low rate charge and discharge.

The batteries were then dismantled into their components. Samples of the electrodes and separator were cut. Each sample weighed approximately 5 g each. Care was taken not to compress the samples during this sample cutting process to ensure a minimum moisture loss during this process. Additionally for the positive electrode, care was taken to avoid including the inert Pb grid/frame material in the sample.

The samples were then placed into a Moisture Analyser (AND™ ML-50 Industrial Precision Moisture Analyser available from Total Lab Systems) where the operating conditions were defined by a maximum temperature of 150° C. with measurement of the sample determined when the rate of mass loss fell below 0.2% per minute. The results are set out in Table 4 below.

TABLE 4

| Battery (60 Ah) | Electrode | Moisture content (%) |
|---|---|---|
| Invention (AGM) | Negative | 4.6 |
| | Positive | 8.7 |
| Control (flooded) | Negative | 10 |
| | Positive | 8.7 |

### Results

The negative in the battery of the invention had a moisture content of 4.6% in comparison to the control battery where the negative had a 10% moisture content. The moisture content of the positive electrode in both the battery of the invention and in the control battery was the same and significantly higher than that of the negative in the battery of the invention.

The following numbered paragraphs define particular aspects and embodiments of the present invention:

1. A lead-acid battery or cell, wherein the battery or cell is a non-gel lead-acid battery or cell or an absorptive glass mat (AGM) lead-acid battery or cell, comprising:
a positive electrode comprising a positive active material (PAM);
a negative electrode comprising a negative active material (NAM); and a separator capable of immobilising an electrolyte disposed between the positive and negative electrodes,
the positive electrode and negative electrode each having a pore size diameter distribution measured by mercury porosimetry,
wherein the pore size diameter distribution of the positive and/or negative electrode comprises a ratio of a volume of pores having a pore size diameter greater than 20 μm to a total pore volume of at least 15%.

2. A lead-acid battery or cell, wherein the battery or cell is a non-gel lead-acid battery or cell or an absorptive glass mat (AGM) lead-acid battery or cell, comprising:
a positive electrode comprising a positive active material (PAM);
a negative electrode comprising a negative active material (NAM); and a separator capable of immobilising an electrolyte disposed between the positive and negative electrodes,
the positive electrode and negative electrode each having a pore size diameter distribution measured by mercury porosimetry,
wherein the pore size diameter distribution of the positive and/or negative electrode comprises a volume of pores having a pore size diameter greater than 20 μm of at least 0.020 ml/g.

3. A lead-acid battery or cell, wherein the battery or cell is a non-gel lead-acid battery or cell or an absorptive glass mat (AGM) lead-acid battery or cell, comprising:
a positive electrode comprising a positive active material (PAM);
a negative electrode comprising a negative active material (NAM); and a separator capable of immobilising an electrolyte disposed between the positive and negative electrodes,
the positive electrode and negative electrode each having a pore size diameter distribution measured by mercury porosimetry,
wherein the pore size diameter distribution of the positive and/or negative electrode comprises:
(a) a ratio of a volume of pores having a pore size diameter greater than 10 μm to a total pore volume of at least 50%, 55%, 60%, 65%, or 70%;
(b) a ratio of a volume of pores having a pore size diameter greater than 15 μm to a total pore volume of at least 25%, 30%, 35%, 40%, 45%, 50%, or 55%;
(c) a ratio of a volume of pores having a pore size diameter greater than 20 μm to a total pore volume of at least 15%, 20%, 25%, 30%, 40%, or 45%;
(d) a ratio of a volume of pores having a pore size diameter greater than 25 μm to a total pore volume of at least 15%, 20%, 25% or 30%;
(e) a ratio of a volume of pores having a pore size diameter greater than 30 μm to a total pore volume of at least 10%, 15%, 20%, or 25%;
(f) a ratio of a volume of pores having a pore size diameter greater than 35 μm to a total pore volume of at least 10%, 15%, or 20%; or
(g) any combination of two or more of (a) to (f).

4. A lead-acid battery or cell, wherein the battery or cell is a non-gel lead-acid battery or cell or an absorptive glass mat (AGM) lead-acid battery or cell, comprising:
a positive electrode comprising a positive active material (PAM);
a negative electrode comprising a negative active material (NAM); and a separator capable of immobilising an electrolyte disposed between the positive and negative electrodes,
the positive electrode and negative electrode each having a pore size diameter distribution measured by mercury porosimetry,
wherein the pore size diameter distribution of the positive and/or negative electrode comprises:
(a) a volume of pores having a pore size diameter greater than 10 μm of at least 0.070, 0.075, 0.080, 0.085, 0.090, 0.095, 0.100, 0.110, or 0.120 ml/g;
(b) a volume of pores having a pore size diameter greater than 15 μm of at least 0.035, 0.040, 0.050, 0.060, 0.070, 0.080, 0.090, or 0.095 ml/g;
(c) a volume of pores having a pore size diameter greater than 20 μm of at least 0.020, 0.025, 0.030, 0.035, 0.040, 0.045, 0.050, 0.055, 0.060, 0.065, 0.070, 0.075, 0.080, 0.085, 0.090, 0.095, or 0.100 ml/g;
(d) a volume of pores having a pore size diameter greater than 25 μm of at least 0.015, 0.020, 0.025, 0.030, 0.035, 0.040, or 0.050 ml/g;
(e) a volume of pores having a pore size diameter greater than 30 μm of at least 0.015, 0.020, 0.025, 0.030, 0.035, 0.040 ml/g;
(f) a volume of pores having a pore size diameter greater than 35 μm of at least 0.010, 0.015, 0.020, 0.025, or 0.030 ml/g; or
(g) any combination of two or more of (a) to (f).

5. The lead-acid battery or cell of any preceding paragraph, wherein the battery or cell is a non-gel lead-acid battery or cell.

6. The lead acid battery or cell of any preceding paragraph, wherein the battery or cell is an absorptive glass mat (AGM) lead-acid battery or cell.

7. A non-gel lead-acid battery or cell comprising:
a positive electrode comprising a positive active material (PAM);
a negative electrode comprising a negative active material (NAM); and
a separator capable of immobilising an electrolyte disposed between the positive and negative electrodes,
the positive electrode and negative electrode each having a pore size diameter distribution measured by mercury porosimetry, and the separator having a pore size diameter distribution measured by capillary flow porometry,
wherein the pore size diameter distribution of the positive and/or negative electrode comprises a ratio of a volume of pores having a pore size diameter greater than 10 μm to a total pore volume of at least 50%.

8. A non-gel lead-acid battery or cell comprising:
a positive electrode comprising a positive active material (PAM);
a negative electrode comprising a negative active material (NAM); and
a separator capable of immobilising an electrolyte disposed between the positive and negative electrodes,
the positive electrode and negative electrode each having a pore size diameter distribution measured by mercury porosimetry, and the separator having a pore size diameter distribution measured by capillary flow porometry,
wherein the pore size diameter distribution of the positive and/or negative electrode comprises:
(a) a ratio of a volume of pores having a pore size diameter greater than 2 μm to a total pore volume of at least 85%;
(b) a ratio of a volume of pores having a pore size diameter greater than 3 μm to a total pore volume of at least 80%;
(c) a ratio of a volume of pores having a pore size diameter greater than 4 μm to a total pore volume of at least 75%;
(d) a ratio of a volume of pores having a pore size diameter greater than 5 μm to a total pore volume of at least 75%;
(e) a ratio of a volume of pores having a pore size diameter greater than 6 μm to a total pore volume of at least 70%;
(f) a ratio of a volume of pores having a pore size diameter greater than 7 μm to a total pore volume of at least 70%;
(g) a ratio of a volume of pores having a pore size diameter greater than 8 μm to a total pore volume of at least 65%;
(h) a ratio of a volume of pores having a pore size diameter greater than 9 μm to a total pore volume of at least 55%;
(1) a ratio of a volume of pores having a pore size diameter greater than 10 μm to a total pore volume of at least 50%; or
(l) any combination of two or more of (a) to (i).

9. A non-gel lead-acid battery or cell comprising:
a positive electrode comprising a positive active material (PAM);
a negative electrode comprising a negative active material (NAM); and
a separator capable of immobilising an electrolyte disposed between the positive and negative electrodes,
the positive electrode and negative electrode each having a pore size diameter distribution measured by mercury porosimetry, and the separator having a pore size diameter distribution measured by capillary flow porometry,
wherein the pore size diameter distribution of the positive and/or negative electrode comprises a ratio of a volume of pores having a pore size diameter greater than a mode pore size diameter of the separator disposed between the electrodes to a total pore volume of at least 80%.

10. An absorptive glass mat (AGM) lead-acid battery or cell comprising:
a positive electrode comprising a positive active material (PAM);
a negative electrode comprising a negative active material (NAM); and
a separator capable of immobilising an electrolyte disposed between the positive and negative electrodes comprising, consisting essentially of, or consisting of an absorptive glass fibre mat,
the positive electrode and negative electrode each having a pore size diameter distribution measured by mercury porosimetry, and the separator having a pore size diameter distribution measured by capillary flow porometry,
wherein the pore size diameter distribution of the positive and/or negative electrode comprises a ratio of a volume of pores having a pore size diameter greater than 10 μm to a total pore volume of at least 50%.

11. An absorptive glass mat (AGM) lead-acid battery or cell comprising:
a positive electrode comprising a positive active material (PAM);
a negative electrode comprising a negative active material (NAM); and
a separator capable of immobilising an electrolyte disposed between the positive and negative electrodes comprising, consisting essentially of, or consisting of an absorptive glass fibre mat,
the positive electrode and negative electrode each having a pore size diameter distribution measured by mercury porosimetry, and the separator having a pore size diameter distribution measured by capillary flow porometry,
wherein the pore size diameter distribution of the positive and/or negative electrode comprises:
(a) a ratio of a volume of pores having a pore size diameter greater than 2 μm to a total pore volume of at least 85%;
(b) a ratio of a volume of pores having a pore size diameter greater than 3 μm to a total pore volume of at least 80%;
(c) a ratio of a volume of pores having a pore size diameter greater than 4 μm to a total pore volume of at least 75%;
(d) a ratio of a volume of pores having a pore size diameter greater than 5 μm to a total pore volume of at least 75%;
(e) a ratio of a volume of pores having a pore size diameter greater than 6 μm to a total pore volume of at least 70%;
(f) a ratio of a volume of pores having a pore size diameter greater than 7 μm to a total pore volume of at least 70%;
(g) a ratio of a volume of pores having a pore size diameter greater than 8 μm to a total pore volume of at least 65%;
(h) a ratio of a volume of pores having a pore size diameter greater than 9 μm to a total pore volume of at least 55%;
(i) a ratio of a volume of pores having a pore size diameter greater than 10 μm to a total pore volume of at least 50%; or
(l) any combination of two or more of (a) to (i).

12. An absorptive glass mat (AGM) lead-acid battery or cell comprising:
a positive electrode comprising a positive active material (PAM);
a negative electrode comprising a negative active material (NAM); and
a separator capable of immobilising an electrolyte disposed between the positive and negative electrodes comprising, consisting essentially of, or consisting of an absorptive glass fibre mat,
the positive electrode and negative electrode each having a pore size diameter distribution measured by mercury porosimetry, and the separator having a pore size diameter distribution measured by capillary flow porometry,
wherein the pore size diameter distribution of the positive and/or negative electrode comprises a ratio of a volume of pores having a pore size diameter greater than a mode pore size diameter of the separator disposed between the electrodes to a total pore volume of at least 80%.

13. The lead-acid battery or cell of any preceding paragraph, wherein the negative electrode has said pore size diameter distribution, or both the negative and positive electrode have said pore size diameter distribution.

14. The lead-acid battery or cell of any preceding paragraph, wherein the battery or cell is a VRLA battery or cell.

15. The lead-acid battery or cell of any one of paragraphs 1-4, 6, 7-9, 13 and 14, wherein the battery or cell is an absorptive glass mat (AGM) battery, wherein the separator comprises, consists essentially of, or consists of an absorptive glass fibre mat.

16. The lead-acid battery or cell of any preceding paragraph, wherein the battery is a bipolar lead-acid battery.

17. The lead-acid battery of paragraph 16, wherein the bipolar lead-acid battery comprises:
one or more bipolar plate, each bipolar plate comprising
   an electrically conductive substrate,
   a positive electrode comprising a positive active material (PAM), and a negative electrode comprising a negative active material (NAM),
   wherein the positive electrode is located on a first surface of the electrically conductive substrate and the negative electrode located on a second surface of the electrically conductive substrate opposite the first surface;
a positive end comprising a positive electrode optionally comprising a positive active material (PAM);
a negative end comprising a negative electrode optionally comprising a negative active material (NAM); and
separators disposed between each negative electrode and positive electrode;
the positive electrodes and negative electrodes each having a pore size diameter distribution measured by mercury porosimetry, and the separators each having a pore size diameter distribution measured by capillary flow porometry,
wherein the battery comprises at least one cell wherein the pore size diameter distribution of the positive and/or negative electrode is as defined in any of paragraphs 1-16.

18. The lead acid battery or cell of any one of paragraphs 1-8, 10, 11, and 13-17, wherein the separator has a pore size diameter distribution measured by capillary flow porometry, wherein the pore size diameter distribution of the positive and/or negative electrode comprises a ratio of the volume of pores greater than the mode pore size diameter of the separator to the total pore volume of at least 80% or 85%.

19. The lead-acid battery or cell of any preceding paragraph, wherein the separator has a pore size diameter distribution measured by capillary flow porometry, wherein the pore size diameter distribution of the positive and/or negative electrode comprises a ratio of the volume of pores greater than the mode pore size diameter of the separator to the total pore volume of at least 85%.

20. The lead-acid battery or cell of any preceding paragraph, wherein the separator has a pore size diameter distribution measured by capillary flow porometry, wherein the separator has a mode pore size diameter less than or equal to about 20 μm, 18 μm, 16 μm, 15 μm, 14 μm, 13 μm, 12 μm, 11 μm, 10 μm, 9 μm, 8 μm, 7 μm, 6 μm, 5 μm, 4 μm, 3 μm, 2 μm, or 1 μm.

21. The lead-acid battery or cell of any preceding paragraph, wherein the separator has a pore size diameter distribution measured by capillary flow porometry, wherein the separator has a mode pore size diameter from about 1 to 20 μm, 1 to 18 μm, 1 to 16 μm, 1 to 15 μm, 1 to 14 μm, 1 to 13 μm, 1 to 12 μm, 1 to 11 μm, 1 to 10 μm, 1 to 9 μm, 1 to 8 μm, 1 to 7 μm, 1 to 6 μm, 1 to 5 μm, 2 to 20 μm, 2 to 18 μm, 2 to 16 μm, 2 to 15 μm, 2 to 14 μm, 2 to 13 μm, 2 to 12 μm, 2 to 11 μm, 2 to 10 μm, 2 to 9 μm, 2 to 8 μm, 2 to 7 μm, 2 to 6 μm, 2 to 5 μm, 3 to 20 μm, 3 to 18 μm, 3 to 16 μm, 3 to 15 μm, 3 to 14 μm, 3 to 13 μm, 3 to 12 μm, 3 to 11 μm, 3 to 10 μm, 3 to 9 μm, 3 to 8 μm, 3 to 7 μm, 3 to 6 μm, 3 to 5 μm, 4 to 20 μm, 4 to 18 μm, 4 to 16 μm, 4 to 15 μm, 4 to 14 μm, 4 to 13 μm, 4 to 12 μm, 4 to 11 μm, 4 to 10 μm. 4 to 9 μm, 4 to 8 μm, 4 to 7 μm, 4 to 6 μm, 4 to 5 μm, 5 to 20 μm, 5 to 18 μm, 5 to 16 μm, 5 to 15 μm, 5 to 14 μm, 5 to 13 μm, 5 to 12 μm, 5 to 11 μm, 5 to 10 μm. 5 to 9 μm, 5 to 8 μm, 5 to 7 μm, or 5 to 6 μm.

22. The lead-acid battery or cell of any preceding paragraph, wherein the positive and/or negative electrode are formed from a paste which at impregnation has a density of from about 1.5 to 5 or from about 1.5 to 5.5 g/cm³.

23. The lead-acid battery or cell of any preceding paragraph, wherein at least the negative electrode comprises said pore size diameter distribution.

24. An electrode for a lead-acid battery or cell comprising an active material and having a pore size diameter distribution measured by mercury porosimetry, wherein the pore size diameter distribution comprises a ratio of a volume of pores having a pore size diameter greater than 20 μm to a total pore volume of at least 15%.

25. An electrode for a lead-acid battery or cell comprising an active material and having a pore size diameter distribution measured by mercury porosimetry, wherein the pore size diameter distribution of the positive and/or negative electrode comprises a volume of pores having a pore size diameter greater than 20 μm of at least 0.020 ml/g.

26. An electrode for a lead-acid battery or cell comprising an active material and having a pore size diameter distribution measured by mercury porosimetry, wherein the pore size diameter distribution comprises:
(a) a ratio of a volume of pores having a pore size diameter greater than 10 μm to a total pore volume of at least 50%, 55%, 60%, 65%, or 70%;
(b) a ratio of a volume of pores having a pore size diameter greater than 15 μm to a total pore volume of at least 25%, 30%, 35%, 40%, 45%, 50%, or 55%;
(c) a ratio of a volume of pores having a pore size diameter greater than 20 μm to a total pore volume of at least 15%, 20%, 25%, 30%, 40%, or 45%;
(d) a ratio of a volume of pores having a pore size diameter greater than 25 μm to a total pore volume of at least 15%, 20%, 25% or 30%;
(e) a ratio of a volume of pores having a pore size diameter greater than 30 μm to a total pore volume of at least 10%, 15%, 20%, or 25%;
(f) a ratio of a volume of pores having a pore size diameter greater than 35 μm to a total pore volume of at least 10%, 15%, or 20%; or
(g) any combination of two or more of (a) to (f).

27. An electrode for a lead-acid battery or cell comprising an active material and having a pore size diameter distribution measured by mercury porosimetry, wherein the pore size diameter distribution comprises:
(a) a volume of pores having a pore size diameter greater than 10 μm of at least 0.070, 0.075, 0.080, 0.085, 0.090, 0.095, 0.100, 0.110, or 0.120 ml/g;
(b) a volume of pores having a pore size diameter greater than 15 μm of at least 0.035, 0.040, 0.050, 0.060, 0.070, 0.080, 0.090, or 0.095 ml/g;
(c) a volume of pores having a pore size diameter greater than 20 μm of at least 0.020, 0.025, 0.030, 0.035, 0.040, 0.045, 0.050, 0.055, 0.060, 0.065, 0.070, 0.075, 0.080, 0.085, 0.090, 0.095, or 0.100 ml/g;
(d) a volume of pores having a pore size diameter greater than 25 μm of at least 0.015, 0.020, 0.025, 0.030, 0.035, 0.040, or 0.050 ml/g;
(e) a volume of pores having a pore size diameter greater than 30 μm of at least 0.015, 0.020, 0.025, 0.030, 0.035, 0.040 ml/g;
(f) a volume of pores having a pore size diameter greater than 35 μm of at least 0.010, 0.015, 0.020, 0.025, or 0.030 ml/g; or
(g) any combination of two or more of (a) to (f).

28. An electrode for a lead-acid battery or cell comprising an active material and having a pore size diameter distribution measured by mercury porosimetry, wherein the pore size diameter distribution comprises a ratio of a volume of pores having a pore size diameter greater than 10 μm to a total pore volume of at least 50%.

29. An electrode for a lead-acid battery or cell comprising an active material and having a pore size diameter distribution measured by mercury porosimetry, wherein the pore size diameter distribution comprises:
(a) a ratio of a volume of pores having a pore size diameter greater than 2 μm to a total pore volume of at least 85%;
(b) a ratio of a volume of pores having a pore size diameter greater than 3 μm to a total pore volume of at least 80%;
(c) a ratio of a volume of pores having a pore size diameter greater than 4 μm to a total pore volume of at least 75%;
(d) a ratio of a volume of pores having a pore size diameter greater than 5 μm to a total pore volume of at least 75%;
(e) a ratio of a volume of pores having a pore size diameter greater than 6 μm to a total pore volume of at least 70%;
(f) a ratio of a volume of pores having a pore size diameter greater than 7 μm to a total pore volume of at least 70%;
(g) a ratio of a volume of pores having a pore size diameter greater than 8 μm to a total pore volume of at least 65%;
(h) a ratio of a volume of pores having a pore size diameter greater than 9 μm to a total pore volume of at least 55%;
(1) a ratio of a volume of pores having a pore size diameter greater than 10 μm to a total pore volume of at least 50%; or
G) any combination of two or more of (a) to (i).

30. The electrode of any one of paragraphs 24 to 29, wherein the electrode is a negative electrode.

31. The lead-acid battery or cell or electrode of any preceding paragraph, wherein the pore size diameter distribution comprises:
(a) a ratio of a volume of pores having a pore size diameter greater than 10 μm to a total pore volume of at least 50%, 55%, 60%, 65%, or 70%;
(b) a ratio of a volume of pores having a pore size diameter greater than 20 μm to a total pore volume of at least 15%, 20%, 25%, 30%, 40%, or 45%; and
(c) a ratio of a volume of pores having a pore size diameter greater than 30 μm to a total pore volume of at least 10%, 15%, 20%, or 25%.

32. The lead-acid battery or cell or electrode of any preceding paragraph, wherein the pore size diameter distribution comprises:
(a) a ratio of a volume of pores having a pore size diameter greater than 20 μm to a total pore volume of at least 15%, 20%, 25%, 30%, 40%, or 45%; and
(b) a ratio of a volume of pores having a pore size diameter greater than 30 μm to a total pore volume of at least 10%, 15%, 20%, or 25%.

33. The lead-acid battery or cell or electrode of any preceding paragraph, wherein the pore size diameter distribution comprises:
(a) a ratio of a volume of pores having a pore size diameter greater than 20 μm to a total pore volume of at least 15%, 20%, 25%, 30%, 40%, or 45%;
(b) a ratio of a volume of pores having a pore size diameter greater than 25 μm to a total pore volume of at least 15%, 20%, 25% or 30%; and
(c) a ratio of a volume of pores having a pore size diameter greater than 30 μm to a total pore volume of at least 10%, 15%, 20%, or 25%;

34. The lead-acid battery or cell or electrode of any preceding paragraph, wherein the pore size diameter distribution comprises:
(a) a volume of pores having a pore size diameter greater than 10 μm of at least 0.070, 0.075, 0.080, 0.085, 0.090, 0.095, 0.100, 0.110, or 0.120 ml/g;
(b) a volume of pores having a pore size diameter greater than 20 μm of at least 0.020, 0.025, 0.030, 0.035, 0.040, 0.045, 0.050, 0.055, 0.060, 0.065, 0.070, 0.075, 0.080, 0.085, 0.090, 0.095, or 0.100 ml/g; and
(c) a volume of pores having a pore size diameter greater than 30 μm of at least 0.015, 0.020, 0.025, 0.030, 0.035, 0.040 ml/g.

35. The lead-acid battery or cell or electrode of any preceding paragraph, wherein the pore size diameter distribution comprises:
(a) a volume of pores having a pore size diameter greater than 20 μm of at least 0.020, 0.025, 0.030, 0.035, 0.040, 0.045, 0.050, 0.055, 0.060, 0.065, 0.070, 0.075, 0.080, 0.085, 0.090, 0.095, or 0.100 ml/g; and
(b) a volume of pores having a pore size diameter greater than 30 μm of at least 0.015, 0.020, 0.025, 0.030, 0.035, 0.040 ml/g.

36. The lead-acid battery or cell or electrode of any preceding paragraph, wherein the pore size diameter distribution comprises:
(a) a volume of pores having a pore size diameter greater than 20 μm of at least 0.020, 0.025, 0.030, 0.035, 0.040, 0.045, 0.050, 0.055, 0.060, 0.065, 0.070, 0.075, 0.080, 0.085, 0.090, 0.095, or 0.100 ml/g;
(b) a volume of pores having a pore size diameter greater than 25 μm of at least 0.015, 0.020, 0.025, 0.030, 0.035, 0.040, or 0.050 ml/g; and
(c) a volume of pores having a pore size diameter greater than 30 μm of at least 0.015, 0.020, 0.025, 0.030, 0.035, 0.040 ml/g.

37. The lead-acid battery or cell or electrode of any one of paragraphs 2-36, wherein the pore size diameter distribution of the electrode or of the positive and/or negative electrode comprises a ratio of a volume of pores having a pore size diameter greater than 20 μm to a total pore volume of at least 15%, 20%, 25%, 30%, 40%, or 45%.

38. The lead-acid battery or cell or electrode of any preceding paragraph, wherein the pore size diameter distribution of the electrode or of the positive and/or negative electrode comprises a ratio of a volume of pores having a pore size diameter greater than 20 μm to a total pore volume of at least 20%, 25%, 30%, 40%, or 45%.

39. The lead-acid battery or cell or electrode of any preceding paragraph, wherein the pore size diameter distribution of the electrode or of the positive and/or negative electrode comprises a ratio of a volume of pores having a pore size diameter greater than 20 μm to a total pore volume of at least 30%, 40%, or 45%.

40. The lead-acid battery or cell or electrode of any one of paragraphs 1 and 3-39, wherein the pore size diameter distribution of the electrode or of the positive and/or negative electrode comprises a volume of pores having a pore size diameter greater than 20 μm of at least 0.020, 0.025, 0.030, 0.035, 0.040, 0.045, 0.050, 0.055, 0.060, 0.065, 0.070, 0.075, 0.080, 0.085, 0.090, 0.095, or 0.100 ml/g.

41. The lead-acid battery or cell or electrode of any preceding paragraph, wherein the pore size diameter distribution of the electrode or of the positive and/or negative electrode comprises a volume of pores having a pore size diameter greater than 20 μm of at least 0.030, 0.035, 0.040, 0.045, 0.050, 0.055, 0.060, 0.065, 0.070, 0.075, 0.080, 0.085, 0.090, 0.095, or 0.100 ml/g.

42. The lead-acid battery or cell or electrode of any preceding paragraph, wherein the pore size diameter distribution of the electrode or of the positive and/or negative electrode comprises a volume of pores having a pore size diameter greater than 20 μm of at least 0.040, 0.045, 0.050, 0.055, 0.060, 0.065, 0.070, 0.075, 0.080, 0.085, 0.090, 0.095, or 0.100 ml/g.

43. The lead-acid battery or cell or electrode of any preceding paragraph, wherein the pore size diameter distribution of the electrode or of the positive and/or negative electrode comprises a total pore volume of at least about 0.135, 0.140, 0.145, 0.150, 0.155, 0.160, 0.165, 0.170, 0.175, 0.180, 0.185, 0.190, 0.195, or 0.200 ml/g.

44. The lead-acid battery or cell or electrode of any preceding paragraph, wherein the pore size diameter distribution of the electrode or of the positive and/or negative electrode comprises a total pore volume of at least about 0.150, 0.155, 0.160, 0.165, 0.170, 0.175, 0.180, 0.185, 0.190, 0.195, or 0.200 ml/g.

45. The lead-acid battery or cell or electrode of any preceding paragraph, wherein the electrode or the positive and/or negative electrode having said pore size distribution is formed from a paste having a leady oxide content not greater than 85% or not greater than 84%.

46. The lead-acid battery or cell or electrode of any one of paragraphs 1-6, 8, 9, 11-45, wherein the pore size diameter distribution of the electrode or of the positive and/or negative electrode comprises a ratio of a volume of pores having a pore size diameter greater than 10 μm to a total pore volume of at least 50%, 55%, 60%, 65%, or 70%.

47. The lead-acid battery or cell or electrode of any preceding paragraph, wherein the pore size diameter distribution of the electrode or of the positive and/or negative electrode comprises a volume of pores having a pore size diameter greater than 10 μm of at least 0.070, 0.075, 0.080, 0.085, 0.090, 0.095, 0.100, 0.110, or 0.120 ml/g.

48. The lead-acid battery or cell or electrode of any preceding paragraph, wherein the pore size diameter distribution of the electrode or of the positive and/or negative electrode comprises a volume of pores having a pore size diameter greater than 10 μm of at least 0.070, 0.075, 0.080, 0.085, 0.090, 0.095, 0.100, 0.110, or 0.120 ml/g.

49. The lead-acid battery or cell or electrode of any preceding paragraph, wherein the pore size diameter distribution of the electrode or of the electrode or of the positive and/or negative electrode comprises a ratio of a volume of pores having a pore size diameter greater than 15 μm to a total pore volume of at least 25%, 30%, 35%, 40%, 45%, 50%, or 55%.

50. The lead-acid battery or cell or electrode of any preceding paragraph, wherein the pore size diameter distribution of the electrode or of the electrode or of the positive and/or negative electrode comprises a ratio of a volume of pores having a pore size diameter greater than 15 μm to a total pore volume of at least 45%, 50%, or 55%.

51. The lead-acid battery or cell or electrode of any preceding paragraph, wherein the pore size diameter distribution of the electrode or of the positive and/or negative electrode comprises a volume of pores having a pore size diameter greater than 15 μm of at least 0.035, 0.040, 0.050, 0.060, 0.070, 0.080, 0.090, or 0.095 ml/g.

52. The lead-acid battery or cell or electrode of any preceding paragraph, wherein the pore size diameter distribution of the electrode or of the positive and/or negative electrode comprises a volume of pores having a pore size diameter greater than 15 μm of at least 0.070, 0.080, 0.090, or 0.095 ml/g.

53. The lead-acid battery or cell or electrode of any preceding paragraph, wherein the pore size diameter distribution of the electrode or of the electrode or of the positive and/or negative electrode comprises a ratio of a volume of pores having a pore size diameter greater than 25 μm to a total pore volume of at least 15%, 20%, 25% or 30%.

54. The lead-acid battery or cell or electrode of any preceding paragraph, wherein the pore size diameter distribution of the electrode or of the electrode or of the positive and/or negative electrode comprises a ratio of a volume of pores having a pore size diameter greater than 25 μm to a total pore volume of at least 20%, 25% or 30% . . .

55. The lead-acid battery or cell or electrode of any preceding paragraph, wherein the pore size diameter distribution of the electrode or of the positive and/or negative electrode comprises a volume of pores having a pore size diameter greater than 25 μm of at least 0.015, 0.020, 0.025, 0.030, 0.035, 0.040, or 0.050 ml/g.

56. The lead-acid battery or cell or electrode of any preceding paragraph, wherein the pore size diameter distribution of the electrode or of the positive and/or negative electrode comprises a volume of pores having a pore size diameter greater than 25 μm of at least 0.025, 0.030, 0.035, 0.040, or 0.050 ml/g.

57. The lead-acid battery or cell or electrode of any preceding paragraph, wherein the pore size diameter distribution of the electrode or of the electrode or of the positive and/or negative electrode comprises a ratio of a volume of pores having a pore size diameter greater than 30 μm to a total pore volume of at least 10%, 15%, 20%, or 25%.

58. The lead-acid battery or cell or electrode of any preceding paragraph, wherein the pore size diameter distribution of the electrode or of the electrode or of the positive and/or negative electrode comprises a ratio of a volume of pores having a pore size diameter greater than 30 μm to a total pore volume of at least 15%, 20%, or 25%.

59. The lead-acid battery or cell or electrode of any preceding paragraph, wherein the pore size diameter distribution of the electrode or of the positive and/or negative electrode comprises a volume of pores having a pore size diameter greater than 30 μm of at least 0.015, 0.020, 0.025, 0.030, 0.035, 0.040 ml/g.

60. The lead-acid battery or cell or electrode of any preceding paragraph, wherein the pore size diameter distribution of the electrode or of the positive and/or negative electrode comprises a volume of pores having a pore size diameter greater than 30 μm of at least 0.020, 0.025, 0.030, 0.035, 0.040 ml/g.

61. The lead-acid battery or cell or electrode of any preceding paragraph, wherein the pore size diameter distribution of the electrode or of the electrode or of the positive and/or negative electrode comprises a ratio of a volume of pores having a pore size diameter greater than 35 μm to a total pore volume of at least 10%, 15%, or 20%.

62. The lead-acid battery or cell or electrode of any preceding paragraph, wherein the pore size diameter distribution of the electrode or of the positive and/or negative electrode comprises a volume of pores having a pore size diameter greater than 35 μm of at least 0.010, 0.015, 0.020, 0.025, or 0.030 ml/g.

63. The lead-acid battery or cell or electrode of any preceding paragraph, wherein the pore size diameter distribution of the electrode or of the positive and/or negative electrode comprises a volume of pores having a pore size diameter greater than 35 μm of at least 0.015, 0.020, 0.025, or 0.030 ml/g.

64. The lead-acid battery or cell or electrode of any preceding paragraph, wherein the pore size diameter distribution of the electrode or of the positive and/or negative electrode comprises a ratio of a volume of pores having a pore size diameter greater than 10 μm to a total pore volume of at least 50%, 55%, 60%, 65%, or 70%; and
(a) a ratio of a volume of pores having a pore size diameter greater than 2 μm to a total pore volume of at least 85% or 90%;
(b) a ratio of a volume of pores having a pore size diameter greater than 3 μm to a total pore volume of at least 80% or 85%;
(c) a ratio of a volume of pores having a pore size diameter greater than 4 μm to a total pore volume of at least 75%, 80%, or 85%;
(d) a ratio of a volume of pores having a pore size diameter greater than 5 μm to a total pore volume of at least 75%, 80%, or 85%;
(e) a ratio of a volume of pores having a pore size diameter greater than 6 μm to a total pore volume of at least 70%, 75%, or 80%;
(f) a ratio of a volume of pores having a pore size diameter greater than 7 μm to a total pore volume of at least 70%, 75%, or 80%;
(g) a ratio of a volume of pores having a pore size diameter greater than 8 μm to a total pore volume of at least 65%, 70%, or 75%;
(h) a ratio of a volume of pores having a pore size diameter greater than 9 μm to a total pore volume of at least 55%, 60%, 65%, 70%, or 75%; or
(i) any combination of two or more of (a) to (h).

65. The lead-acid battery or cell or electrode of any preceding paragraph, wherein the pore size diameter distribution of the electrode or of the positive and/or negative electrode comprises a ratio of the volume of pores greater than 10 μm to the total pore volume of at least 55%, 60%, 65%, or 70%.

66. The lead-acid battery or cell or electrode of any preceding paragraph, wherein the pore size diameter distribution of the electrode or of the electrode or of the positive and/or negative electrode comprises a ratio of the volume of pores greater than 10 μm to the total pore volume of at least 65% or 70%.

67. The lead-acid battery or cell or electrode of any preceding paragraph, wherein the pore size diameter distribution of the electrode or of the positive and/or negative electrode comprises a ratio of a volume of pores having a pore size diameter greater than 1 μm to a total pore volume of at least 95%.

68. The lead-acid battery or cell or electrode of any preceding paragraph, wherein the pore size diameter distribution of the electrode or of the positive and/or negative electrode comprises a ratio of a volume of pores having a pore size diameter greater than 2 μm to a total pore volume of at least 85% or 90%.

69. The lead-acid battery or cell or electrode of any preceding paragraph, wherein the pore size diameter distribution of the electrode or of the positive and/or negative electrode comprises a ratio of a volume of pores having a pore size diameter greater than 3 μm to a total pore volume of at least 80% or 85%.

70. The lead-acid battery or cell or electrode of any preceding paragraph, wherein the pore size diameter distribution of the electrode or of the positive and/or negative electrode comprises a ratio of a volume of pores having a pore size diameter greater than 4 μm to a total pore volume of at least 75%, 80%, or 85%.

71. The lead-acid battery or cell or electrode of any preceding paragraph, wherein the pore size diameter distribution of the electrode or of the positive and/or negative electrode comprises a ratio of a volume of pores having a pore size diameter greater than 5 μm to a total pore volume of at least 75%, 80%, or 85%.

72. The lead-acid battery or cell or electrode of any preceding paragraph, wherein the pore size diameter distribution of the electrode or of the positive and/or negative electrode comprises a ratio of a volume of pores having a pore size diameter greater than 6 μm to a total pore volume of at least 70%, 75%, or 80%.

73. The lead-acid battery or cell or electrode of any preceding paragraph, wherein the pore size diameter distribution of the electrode or of the positive and/or negative electrode comprises a ratio of a volume of pores having a pore size diameter greater than 7 μm to a total pore volume of at least 70%, 75%, or 80%.

74. The lead-acid battery or cell or electrode of any preceding paragraph, wherein the pore size diameter distribution of the electrode or of the positive and/or negative electrode comprises a ratio of a volume of pores having a pore size diameter greater than 8 μm to a total pore volume of at least 65%, 70%, or 75%.

75. The lead-acid battery or cell or electrode of any preceding paragraph, wherein the pore size diameter distribution of the electrode or of the positive and/or negative electrode comprises a ratio of a volume of pores having a pore size diameter greater than 9 μm to a total pore volume of at least 55%, 60%, 65%, 70%, or 75%.

76. The lead-acid battery or cell or electrode of any preceding paragraph, wherein the pore size diameter distribution of the electrode or of the positive and/or negative electrode comprises:
(a) a ratio of a volume of pores having a pore size diameter greater than 3 μm to a total pore volume of at least 80%;
(b) a ratio of a volume of pores having a pore size diameter greater than 5 μm to a total pore volume of at least 75%;
(c) a ratio of a volume of pores having a pore size diameter greater than 7 μm to a total pore volume of at least 70%; and
(d) a ratio of a volume of pores having a pore size diameter greater than 10 μm to a total pore volume of at least 50%.

77. The lead-acid battery or cell or electrode of any one of paragraphs 1-75, wherein the pore size diameter distribution of the electrode or of the positive and/or negative electrode comprises:
(a) a ratio of a volume of pores having a pore size diameter greater than 5 μm to a total pore volume of at least 75%; and
(b) a ratio of a volume of pores having a pore size diameter greater than 10 μm to a total pore volume of at least 50%.

78. The lead-acid battery or cell or electrode of any one of paragraphs 1-75, wherein the pore size diameter distribution of the electrode or of the positive and/or negative electrode comprises:
(a) a ratio of a volume of pores having a pore size diameter greater than 5 μm to a total pore volume of at least 75%; and
(b) a ratio of a volume of pores having a pore size diameter greater than 10 μm to a total pore volume of at least 55%.

79. The lead-acid battery or cell or electrode of any one of paragraphs 1-75, wherein the pore size diameter distribution of the electrode or of the positive and/or negative electrode comprises:
(a) a ratio of a volume of pores having a pore size diameter greater than 3 μm to a total pore volume of at least 80%;
(b) a ratio of a volume of pores having a pore size diameter greater than 5 μm to a total pore volume of at least 75%;
(c) a ratio of a volume of pores having a pore size diameter greater than 7 μm to a total pore volume of at least 70%; and
(d) a ratio of a volume of pores having a pore size diameter greater than 10 μm to a total pore volume of at least 50%.

80. The lead-acid battery or cell or electrode of any one of paragraphs 1-75, wherein the pore size diameter distribution of the electrode or of the positive and/or negative electrode comprises:
(a) a ratio of a volume of pores having a pore size diameter greater than 3 μm to a total pore volume of at least 80%;
(b) a ratio of a volume of pores having a pore size diameter greater than 5 μm to a total pore volume of at least 75%;
(c) a ratio of a volume of pores having a pore size diameter greater than 10 μm to a total pore volume of at least 50%.

81. The electrode of any preceding paragraph, wherein the electrode is formed from a paste which at impregnation has a density of from about 1.5 to 5 g/cm³.

82. A bipolar plate for a bipolar lead-acid battery comprising an electrically conductive substrate, a positive electrode comprising a positive active material (PAM), and a negative electrode comprising a negative active material (NAM),
wherein the positive electrode is located on a first surface of the electrically conductive substrate and the negative electrode located on a second surface of the electrically conductive substrate opposite the first surface; and wherein the positive and/or negative electrode is an electrode of any preceding paragraph.

83. The battery or cell, electrode, or plate of any preceding paragraph, wherein the positive and/or negative electrode comprises an electrode framework in which the active material is disposed.

84. The battery or cell, electrode, or plate of paragraph 83, wherein the electrode framework comprises a fibrous material.

85. The battery or cell, electrode, or plate of paragraph 84, wherein the fibrous material has a bulk density of wherein the fibrous material has a bulk density of about 0.05 g/cm³ to 0.2 g/cm³, 0.07 to 0.17 g/cm³, or 0.08 to 0.15 g/cm³.

86. A method of manufacturing a lead-acid battery or cell according to any preceding paragraph, the method comprising:
providing a positive electrode comprising a positive active material oxide (PAM oxide) paste, a negative electrode comprising a negative active material oxide (NAM oxide) paste, and a separator capable of immobilising an electrolyte;
assembling the battery or cell from the positive electrode, negative electrode, and separator; adding an electrolyte; and subjecting the battery or cell to an initial cell or battery charge for cell formation.

87. The method of paragraph 86, wherein providing the at least one positive electrode and/or at least one negative electrode comprises applying to an electrode framework a positive active material oxide (PAM oxide) paste or a negative active material oxide (NAM oxide) paste.

88. A method of manufacturing an electrode according to any preceding paragraph, the method comprising applying to an electrode framework a positive active material oxide (PAM oxide) paste or a negative active material oxide (NAM oxide) paste.

89. The method of paragraph 87 or 88, wherein the paste is applied to the electrode framework within a confined pasting zone.

90. The method of any one of paragraphs 86-89, wherein the paste at impregnation has a density of from about 1.5 to 5 g/cm³.

The foregoing describes the invention including preferred forms thereof and alterations and modifications as will be obvious to one skilled in the art are intended to be incorporated within the scope hereof as defined in the accompanying claims.

Any documents referred to herein including, but not limited to, patents, patent applications, journal articles, books, and the like, are incorporated herein by reference in their entirety. Any section headings used herein are for organizational purposes only and are not to be construed as limiting the subject matter described.

What is claimed is:

1. A lead-acid battery or cell, wherein the battery or cell is a non-gel lead-acid battery or cell or absorptive glass mat (AGM) lead-acid battery or cell, comprising:
a positive electrode comprising a positive active material (PAM);
a negative electrode comprising a negative active material (NAM); and
a separator capable of immobilising an electrolyte disposed between the positive and negative electrodes,
the positive electrode and negative electrode each having a pore size diameter distribution measured by mercury porosimetry,
wherein the pore size diameter distribution of the positive and/or negative electrode comprises a ratio of a volume of pores having a pore size diameter greater than 20 μm to a total pore volume of at least 15%.

2. The lead-acid battery or cell of claim 1, wherein the pore size diameter distribution of the positive and/or negative electrode comprises a volume of pores having a pore size diameter greater than 20 μm of at least 0.020 ml/g.

3. The lead-acid battery or cell of claim 1, wherein the negative electrode has said pore size diameter distribution, or both the negative and positive electrode have said pore size diameter distribution.

4. The lead-acid battery or cell of claim 1, wherein the battery or cell is an absorptive glass mat (AGM) battery and/or is a bipolar lead-acid battery.

5. (canceled)

6. The lead-acid battery or cell of claim 1, wherein the separator has a pore size diameter distribution measured by capillary flow porometry,
wherein the pore size diameter distribution of the positive and/or negative electrode comprises a ratio of the volume of pores greater than the mode pore size diameter of the separator to the total pore volume of at least 80% or 85%.

7. The lead-acid battery or cell of claim 1, wherein the separator has a pore size diameter distribution measured by capillary flow porometry,
wherein the separator has a mode pore size diameter less than or equal to about 20 μm, 18 μm, 16 μm, 15 μm, 14 μm, 13 μm, 12 μm, 11 μm, 10 μm, 9 μm, 8 μm, 7 μm, 6 μm, 5 μm, 4 μm, 3 μm, 2 μm, or 1 μm.

8. The lead-acid battery or cell of claim 1, wherein the positive and/or negative electrode are formed from a paste which at impregnation has a density of from about 1.5 to 5 or from about 1.5 to 5.5 g/cm³.

9. An electrode for a lead-acid battery or cell comprising an active material and having a pore size diameter distribution measured by mercury porosimetry, wherein the pore size diameter distribution comprises a ratio of a volume of pores having a pore size diameter greater than 20 μm to a total pore volume of at least 15%.

10. The electrode of claim 9,
wherein the pore size diameter distribution of the electrode comprises a volume of pores having a pore size diameter greater than 20 μm of at least 0.020 ml/g.

11. The lead-acid battery or cell or electrode of claim 1,
wherein the pore size diameter distribution of the positive and/or negative electrode comprises a ratio of a volume of pores having a pore size diameter greater than 10 μm to a total pore volume of at least 50%, 55%, 60%, 65%, or 70%.

12. The lead-acid battery or cell of claim 1,
wherein the pore size diameter distribution of the positive and/or negative electrode comprises a volume of pores having a pore size diameter greater than 10 μm of at least 0.070, 0.075, 0.080, 0.085, 0.090, 0.095, 0.100, 0.110, or 0.120 ml/g.

13. (canceled)

14. (canceled)

15. (canceled)

16. (canceled)

17. (canceled)

18. (canceled)

19. The lead-acid battery or cell of claim 1,
wherein the pore size diameter distribution of the electrode er of the positive and/or negative electrode comprises a ratio of a volume of pores having a pore size diameter greater than 35 μm to a total pore volume of at least 10%, 15%, or 20%.

20. The lead-acid battery or cell of claim 1,
wherein the pore size diameter distribution of the positive and/or negative electrode comprises a volume of pores having a pore size diameter greater than 35 μm of at least 0.010, 0.015, 0.020, 0.025, or 0.030 ml/g.

21. The lead-acid battery or cell of claim 1,
wherein the pore size diameter distribution of the positive and/or negative electrode comprises:
(a) a ratio of a volume of pores having a pore size diameter greater than 5 μm to a total pore volume of at least 75%; and
(b) a ratio of a volume of pores having a pore size diameter greater than 10 μm to a total pore volume of at least 50%.

22. A bipolar plate for a bipolar lead-acid battery comprising an electrically conductive substrate,
a positive electrode comprising a positive active material (PAM), and
a negative electrode comprising a negative active material (NAM),
wherein the positive electrode is located on a first surface of the electrically conductive substrate and the negative electrode located on a second surface of the electrically conductive substrate opposite the first surface; and
wherein the positive and/or negative electrode is an electrode of claim 9.

23. The battery or cell of claim 1,
wherein the positive and/or negative electrode comprises an electrode framework in which the active material is disposed.

24. The battery or cell of claim 23, wherein the electrode framework comprises a fibrous material.

25. The electrode of claim 9, wherein the pore size diameter distribution of the electrode comprises a ratio of a volume of pores having a pore size diameter greater than 10 μm to a total pore volume of at least 50%, 55%, 60%, 65%, or 70%.

26. The electrode of claim 9, wherein the pore size diameter distribution of the electrode comprises a ratio of a volume of pores having a pore size diameter greater than 35 μm to a total pore volume of at least 10%, 15%, or 20%.

27. The electrode of claim 9, wherein the pore size diameter distribution of the electrode comprises:
(a) a ratio of a volume of pores having a pore size diameter greater than 5 μm to a total pore volume of at least 75%; and
(b) a ratio of a volume of pores having a pore size diameter greater than 10 μm to a total pore volume of at least 50%.
